(19) United States
(12) Patent Application Publication
(10) Pub. No.: US 2010/0185506 A1
(43) Pub. Date: Jul. 22, 2010

(54) SYSTEMS AND METHODS USED IN THE OPERATION OF A RECYCLING ENTERPRISE

(75) Inventors: Paul Kenneth Wolff, Calabasas, CA (US); Anthony Joaquin Zolezzi, Los Angeles, CA (US); Antonella Commiato, Spring, TX (US); Paul Jerry Ligon, The Woodlands, TX (US); Rohith Kumar Anabheri Venkata, Houston, TX (US)

Correspondence Address: GARDERE WYNNE SEWELL LLP;INTELLECTUAL PROPERTY SECTION, 3000 THANKSGIVING TOWER, 1601 ELM ST, DALLAS, TX, 75201-4761, US

(73) Assignee: WM GreenOps, LLC, Houston, TX (US)

(21) Appl. No.: 12/688,727

(22) Filed: Jan. 15, 2010

Related U.S. Application Data
(63) Continuation-in-part of application No. 12/492,291, filed on Jun. 26, 2009.
(60) Provisional application No. 61/082,095, filed on Jul. 18, 2008.

(51) Int. Cl. G06Q 50/00; G06Q 30/00; G06F 17/30

(52) U.S. Cl. 705/14.31; 705/14.33; 707/780; 235/375; 707/802; 707/E17.005; 707/E17.014

(57) ABSTRACT

A system and computer program product for managing an online recycling operation, including uniquely associating one or more recyclable products with unique identifiers and other product information stored in a database, receiving information associated with the one or more recyclable products, periodically storing and updating the information associated with the one or more recyclable products in the database, associating the unique identifier with a recycling user having user account information stored in the database, updating the reward point total based on an activity of the recycling user, communicating the product information and the user account information to the recycling user over a network, communicating rewards that are available in exchange for reward points to the recycling user over the network, and redeeming reward points upon demand by the recycling user over the network. Each recyclable product includes indicia that uniquely identifies the recyclable product. The user account information includes user information comprising a reward point total and recycling data associated with the recycling user. The activity includes recycling activities and active participation on an environmentally-friendly web server.

### CROSS REFERENCE TO RELATED APPLICATIONS

The present application is a continuation-in-part of and claims priority to co-pending U.S. patent application Ser. No. 12/492,291, entitled “System and Computer Program for Managing and Tracking Recyclable Products,” filed in the U.S. Patent and Trademark Office on Jun. 26, 2009 and having a common inventor as the present document, which claims priority to U.S. provisional application Ser. No. 61/082,095, entitled “Bluedot—Method for the Design, Fabrication, Tracking and Recycling of Consumer Packaging and Products,” filed in the U.S. Patent and Trademark Office on Jul. 18, 2008. Each of the above provisional and non-provisional patent applications is hereby incorporated by reference.

### BACKGROUND OF THE INVENTION

1. Field of the Invention

The present invention is generally related to operations associated with a recycling enterprise, and more particularly to systems and methods used in the operation of a recycling enterprise.

2. Discussion of the Background

Many products are recyclable, including electronic and medical products, plastic bottles, glass, paper, metal containers and other recyclable packaging, containers and products. Such products are known as recyclable products. Similar to other products, recyclable products are manufactured, distributed and sold to consumers, typically at retail locations. After consumption, the consumer may return the recyclable product to a recycling center or station, segregate the recycling product in a recycle bin during trash pickup, or otherwise dispose of the recyclable product in a way that the recyclable product may be recycled. The recyclable product is then recycled and reprocessed.

There are numerous deficiencies associated with recycling in general, and, in particular, with operations associated with a recycling enterprise, including without limitation an efficient way to capture, audit and authenticate recyclable products, maintain and manage attributes and other information relating to recyclable products, track the location of recyclable products during their lifecycle, and reduce the manual labor associated with recycling.

There also exist numerous deficiencies associated with maintaining a rewards program in the field of recycling. Many recyclable products are never recycled and end up in landfills and/or are incinerated which unnecessarily increases waste and pollution. Unfortunately, an efficient way of encouraging consumers to recycle along with managing and tracking such recyclable products does not exist in the prior art.

Until the above-identified deficiencies associated with recycling are resolved, waste and pollution will continue. Thus, there currently exist deficiencies associated with recycling in general, and, in particular, with operating a recycling enterprise.

### SUMMARY OF THE INVENTION

Accordingly, one aspect of the present invention is a computer program product embodied on a computer readable medium for managing an online recycling operation. The computer program product includes a first computer code for uniquely associating one or more recyclable products with unique identifiers and other product information stored in a database, a second computer code for receiving information associated with the one or more recyclable products, a third computer code for periodically storing and updating the information associated with the one or more recyclable products in the database, a fourth computer code for associating the unique identifier with a recycling user having user account information stored in the database, a fifth computer code for updating the reward point total based on an activity of the recycling user, a sixth computer code for communicating the product information and the user account information to the recycling user over a network, a seventh computer code for communicating rewards that are available in exchange for reward points to the recycling user over the network, and an eighth computer code for redeeming reward points upon demand by the recycling user over the network. Each recyclable product includes indicia that uniquely identifies the recyclable product. The user account information includes user information comprising a reward point total and recycling data associated with the recycling user. The activity includes recycling activities and active participation on an environmentally-friendly web server.

Another aspect of the present invention is a system for managing and tracking recyclable products. The system includes a plurality of remote computers of recycling users, a central server, a network interface in communication with the central server and the plurality of remote computers over a network, and a database in communication with the central server. The central server is configured to uniquely associate one or more recyclable products with unique identifiers and other product information stored in a database, receive information associated with the one or more recyclable products, periodically store and update the information associated with the one or more recyclable products in the database, associate the unique identifier with a recycling user having user account information stored in the database, update the reward point total based on an activity of the recycling user, communicate the product information and the user account information to the recycling user over a network, communicate rewards that are available in exchange for reward points to the recycling user over the network and redeem reward points upon demand by the recycling user over the network. The network interface is configured to receive a tracking information associated with one or more recyclable products. Each recyclable product includes indicia that uniquely identifies the recyclable product. The user account information includes user information comprising a reward point total and recycling data associated with the recycling user. The activity includes recycling activities and active participation on an environmentally-friendly web server.

Yet another aspect of the present invention is a computer program product embodied on a computer readable medium for managing an online recycling operation. The computer program product includes a first computer code for uniquely associating one or more recyclable products with unique identifiers and other product information stored in a database, a second computer code for receiving information associated with the one or more recyclable products, a third computer code for periodically storing and updating the information associated with the one or more recyclable products in the database, a fourth computer code for associating the unique identifier with a recycling user having user account information stored in the database, a fifth computer code for updating the reward point total based on a recycling activity of the recycling user, a sixth computer code for communicating the product information and the user account information to the recycling user over a network, and a seventh computer code for redeeming reward points upon demand by the recycling user over the network. Each recyclable product includes indicia that uniquely identifies the recyclable product. The user account information includes user information comprising a reward point total and recycling data associated with the recycling user. The sixth and seventh computer codes are implemented on web server and a recycling station in communication with the database over the network.

Another aspect of the present invention is a computer program product embodied on a computer readable medium for interacting with a recycling user on a recycling center or station. The computer program product includes a first computer code for automatically receiving a user identifier using a recycling center or station, a second computer code for communicating the user identifier from the recycling center or station to a central computer via a communications network, a third computer code for receiving the user identifier at the central computer and associating the user identifier with a recycling user having user account information stored in the database, a fourth computer code for transmitting at least a portion of the user account information from the central computer to the recycling center or station, a fifth computer code for receiving the at least a portion of the user account information at the recycling center or station, and a sixth computer code for implementing a graphical user interface on the recycling center or station to the recycling user. The user account information includes user information includes a reward point total and recycling data associated with the recycling user.

Yet another aspect of the present invention is a computer program product embodied on a computer readable medium for receiving a recyclable product at a materials recovery facility or a recycling center or station. The computer program product includes a first computer code for identifying a recyclable product at a recycling center or station, a second computer code for determining a type of the recyclable product, wherein the type comprises one selected form the group consisting of a bio hazard type and a non-bio hazard type, and a third computer code for routing the recyclable product based on the type to an appropriate processing location.

### BRIEF DESCRIPTION OF THE DRAWINGS

A more complete appreciation of the present invention and many of the attendant advantages thereof will be readily obtained as the same becomes better understood by reference to the following detailed description when considered in conjunction with the accompanying drawings, wherein:

FIG. 1 is a block diagram illustrating an exemplary recycling arrangement associated with a recycling enterprise in accordance with an embodiment of the present invention;

FIGS. 2A-2I are block diagrams illustrating an exemplary database schema associated with a recycling enterprise in accordance with an embodiment of the present invention;

FIG. 3 is a block diagram illustrating an exemplary configuration for providing and accessing information associated with a recycling enterprise over a network in accordance with an embodiment of the present invention;

FIG. 4A is a flow chart illustrating a method for managing and tracking recyclable products in accordance with an embodiment of the present invention;

FIG. 4B is a flow chart illustrating a method for tracking recycling users in accordance with an embodiment of the present invention;

FIGS. 4C and 4D are flow charts illustrating methods for maintaining a rewards program in accordance with an embodiment of the present invention;

FIG. 4E is a flow chart illustrating a method for interacting with a recycling user using a recycling center or station in accordance with an embodiment of the present invention;

FIG. 4F is a flow chart illustrating a method for receiving a recyclable at a materials recovery facility or a recycling center or station product in accordance with an embodiment of the present invention;

FIG. 5A is a block diagram illustrating the placement of an exemplary unique identifier on a recyclable product in accordance with an embodiment of the present invention;

FIG. 5B is a block diagram illustrating an automated recyclable product collection location in accordance with an embodiment of the present invention;

FIG. 6 is a block diagram illustrating exemplary database tables used for managing and tracking recyclable products in accordance with an embodiment of the present invention;

FIG. 7A is a block diagram illustrating an exemplary unique identifier used for managing and tracking recyclable products in accordance with an embodiment of the present invention;

FIG. 7B is a block diagram illustrating an exemplary coding types used for managing and tracking recyclable products in accordance with an embodiment of the present invention;

FIG. 8A is a block diagram illustrating a tracking module implemented by a mobile device that is used to identify and track recycling activities in accordance with an embodiment of the present invention;

FIG. 8B is a block diagram illustrating one possible implementation of a scanning module implemented by a mobile device that is used to scan and review recycling activities in accordance with an embodiment of the present invention;

FIGS. 8C-8G are block diagrams illustrating another possible implementation of a scanning module implemented by a mobile device that is used to scan and review recycling activities in accordance with an embodiment of the present invention;

FIG. 8H is a block diagram illustrating one possible implementation of a web-based recycling scorecard in accordance with an embodiment of the present invention;

FIGS. 9A-9D are block diagrams illustrating one possible implementation of a web-based interface in accordance with an embodiment of the present invention; and

FIGS. 10A-10E are block diagrams illustrating one possible implementation of a recycling center or station interface in accordance with an embodiment of the present invention.

### DETAILED DESCRIPTION THE PREFERRED EMBODIMENTS

Referring now to the drawings, wherein like reference numerals designate identical or corresponding parts throughout the several views, preferred embodiments of the present invention are described.

### I. Managing and Tracking Recyclable Products

The present invention provides a computer program and method for managing and tracking recyclable products, including without limitation a way to easy capture, audit and authenticate recyclable products, maintain and manage attributes and other information relating to the recyclable products, and track the location of recyclable products during their lifecycle. The present invention provides for the easy capture and authentication of recyclable products, and provides the ability to audit the recyclable products.

The present invention provides information associated with the recyclable products, including without limitations the ability to track recyclable products and ascertain other information about such recyclable products, such as its attributes and location. Using the present invention, a recycling user may confirm whether the recyclable product is composed of non-toxic or toxic materials, manage recycling product information, and track the recyclable product during its lifecycle in near real-time using an online web server.

In one embodiment, each recyclable product has a unique identifier and other indicia included in the printed label or product for capturing redundancies. The system uses proprietary algorithms to create unique unit level bar or symbol based security or tracking codes. Security or tracking codes are generated on demand when the recyclable product is manufactured or packaged. An open architecture which allows for flexible integration into various manufacturing environments is utilized. Security or tracking codes may be encrypted with the strongest methodology available with non-sequential, non-predictable and non-repeating codes.

According to one embodiment, recyclable products can be verified at any point in the supply chain via without limitation the Internet, SMS, a hand-held scanner, or a camera phone. Security or tracking codes can be authenticated by manufacturers, security personnel, retail associates and consumers at various stages in the recyclable product's lifecycle. Unit level authentication is available to a user using a camera phone, a hand-held scanner, SMS, or by means of the Internet.

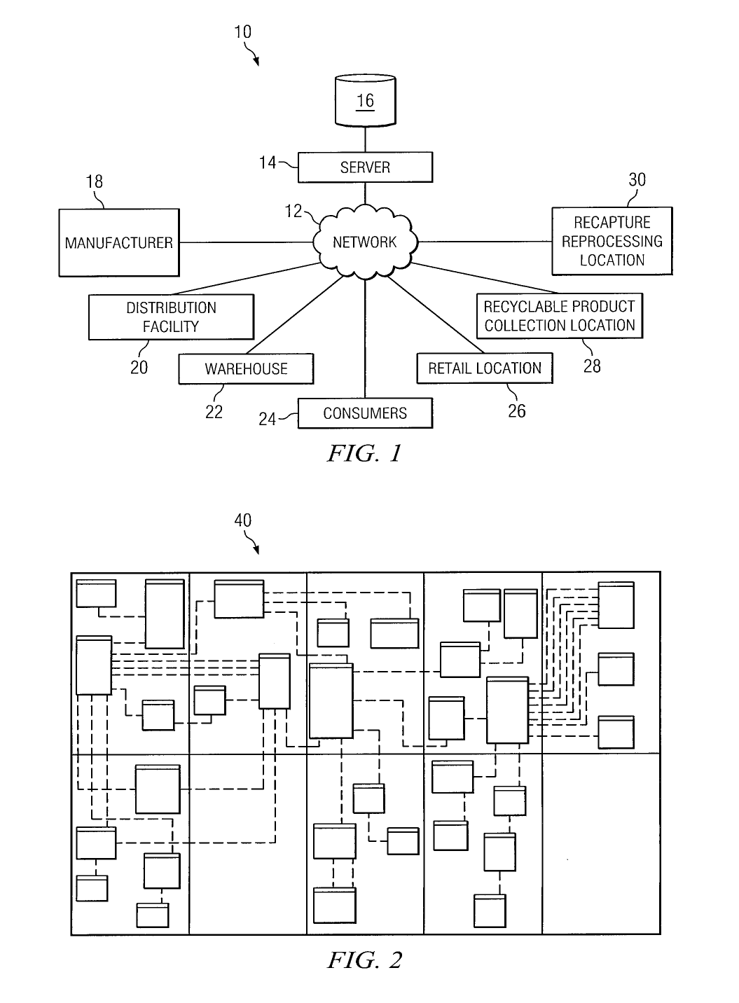

Referring to FIG. 1, a block diagram illustrating an arrangement for managing and tracking recyclable products in accordance with an embodiment of the present invention is shown. According to this arrangement, one or more users associated with a recyclable product's lifecycle communicate with server 14 to access and possibly update information associated with recyclable products. Users associated with a recyclable product's lifecycle or otherwise interested in recycling, referred to herein as recycling users, include without limitation manufacturers 18, distribution facilities 20, warehouses 22, retail locations 24, consumers 26, recyclable product collection locations 28 and recapture reprocessing locations 30. The recyclable product information is stored in one or more databases 16 in communication with server 14.

In one non-limiting embodiment, server 14 is a web server, or the like, able to communicate with one or more users associated with a recyclable product's lifecycle via network 12, such as without limitation the Internet, an Intranet or other communication network. Server 14 includes a computer with one or more processors and a computer readable storage medium, such as without limitation a computer hard-drive, removable drive or memory. A computer program having executable instructions may be stored on the computer readable storage medium.

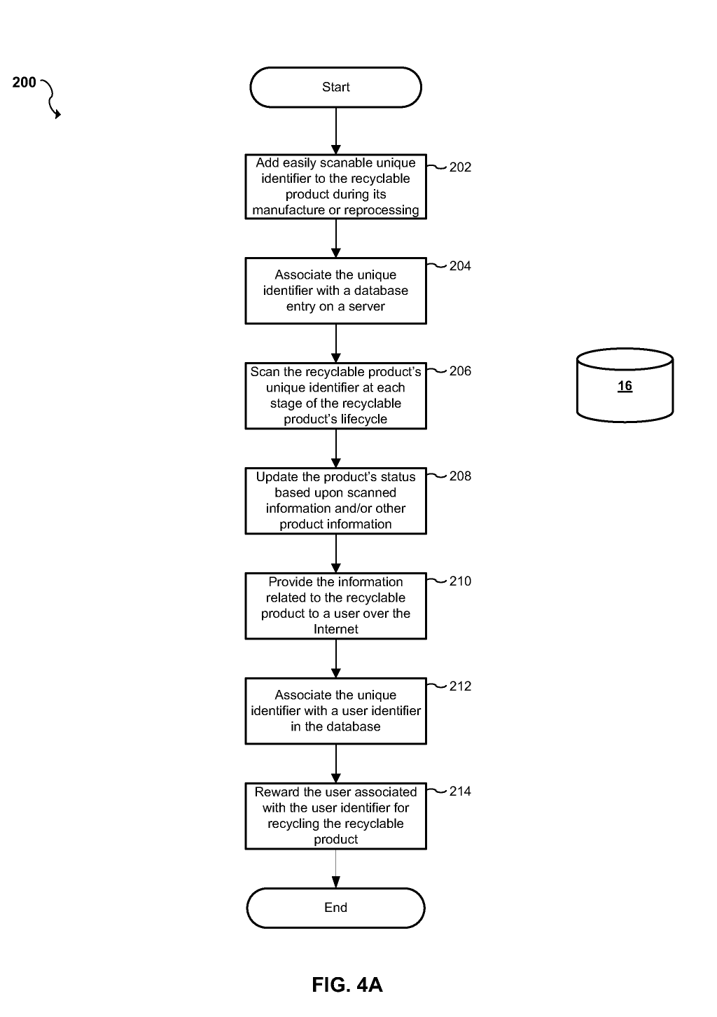

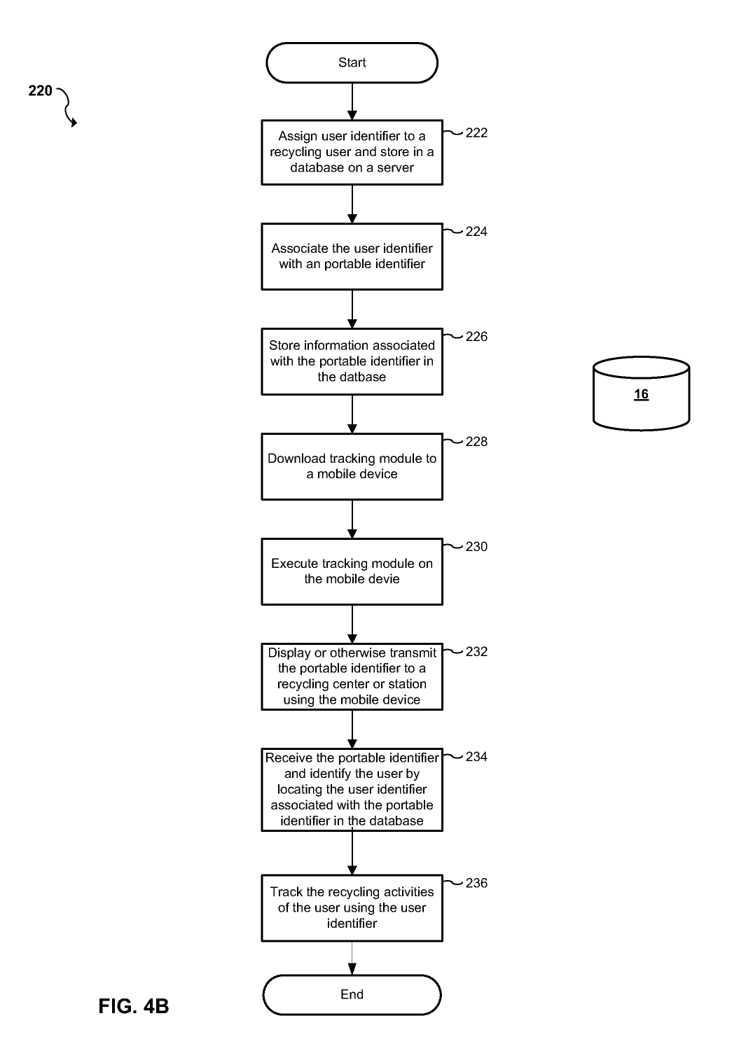

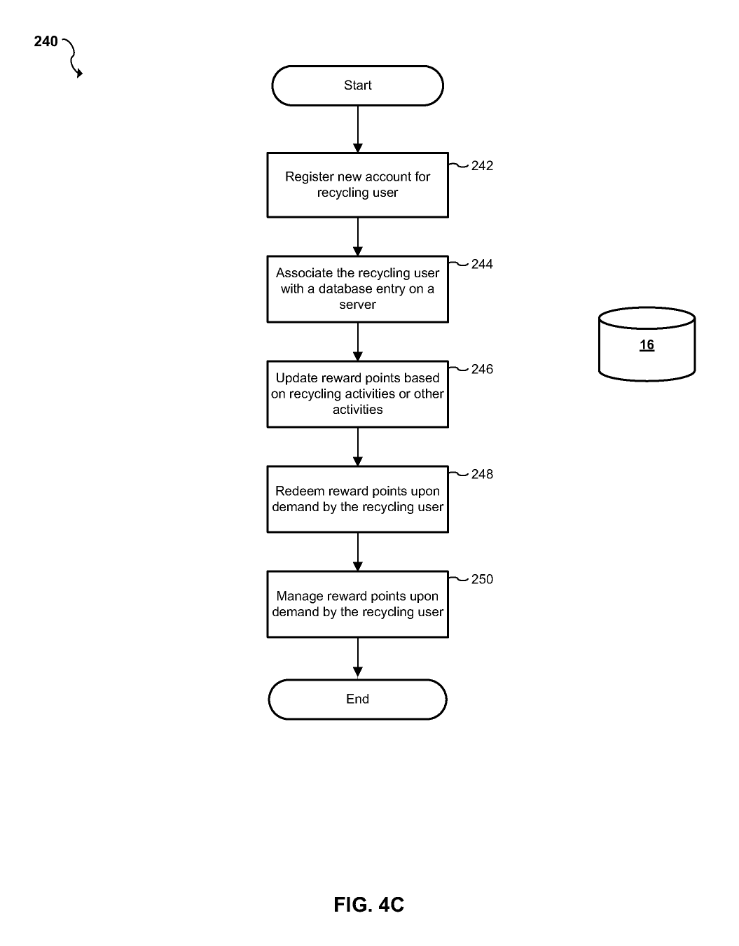

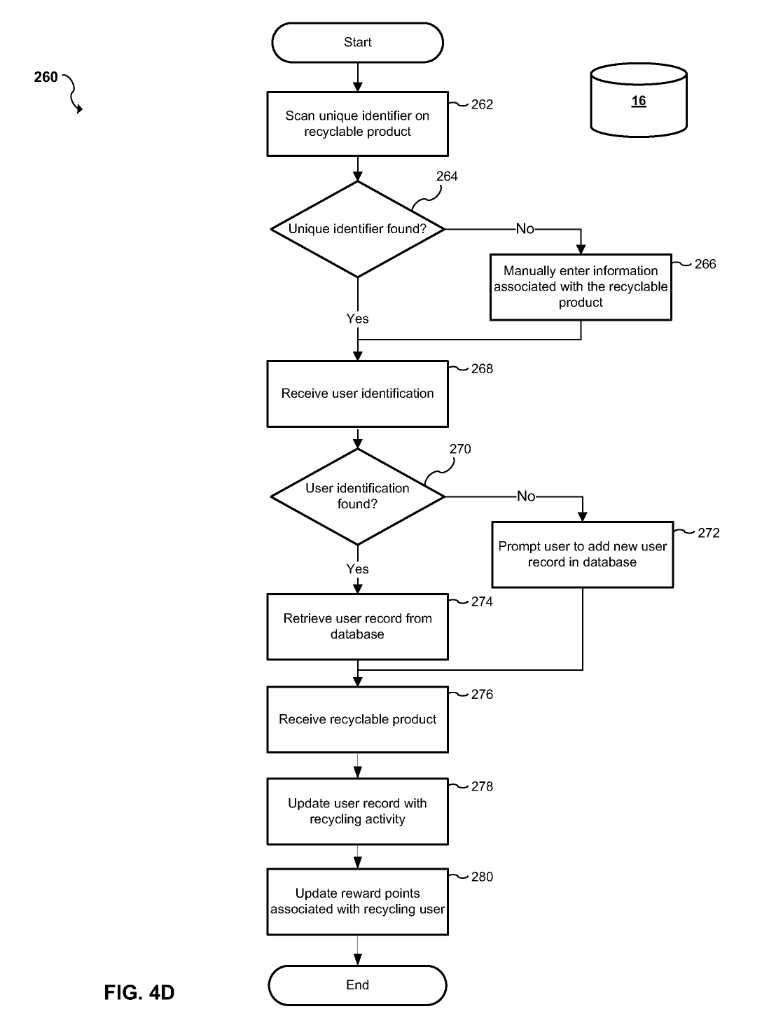

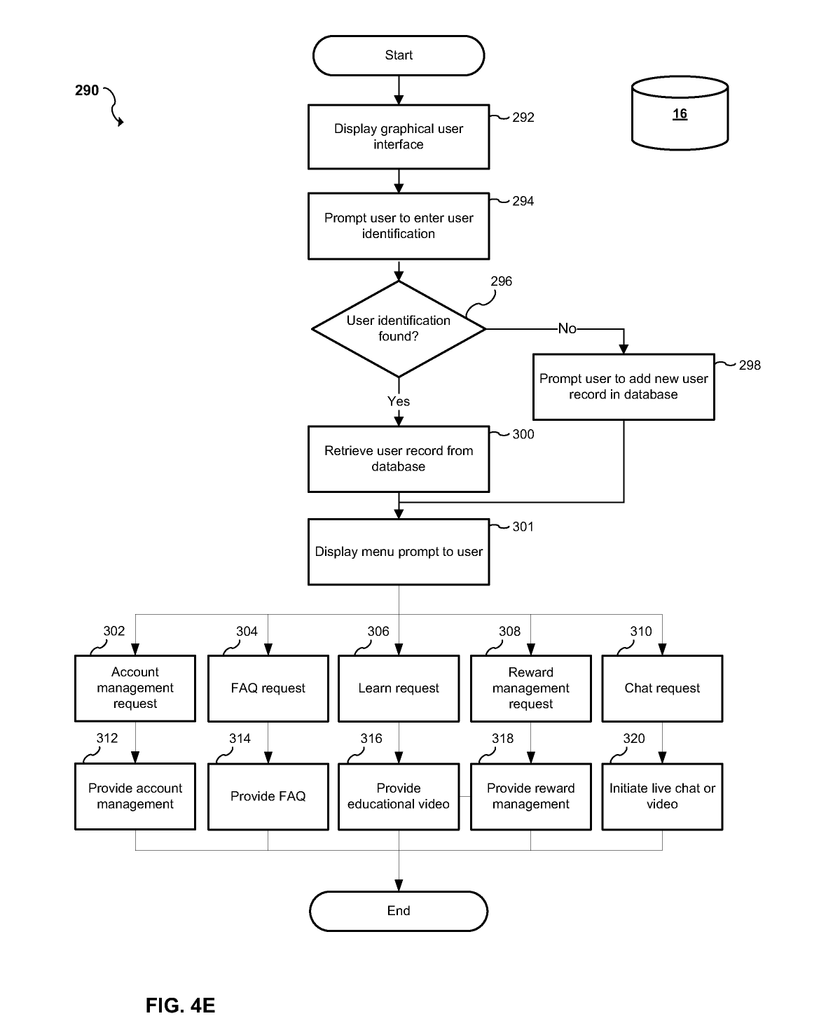

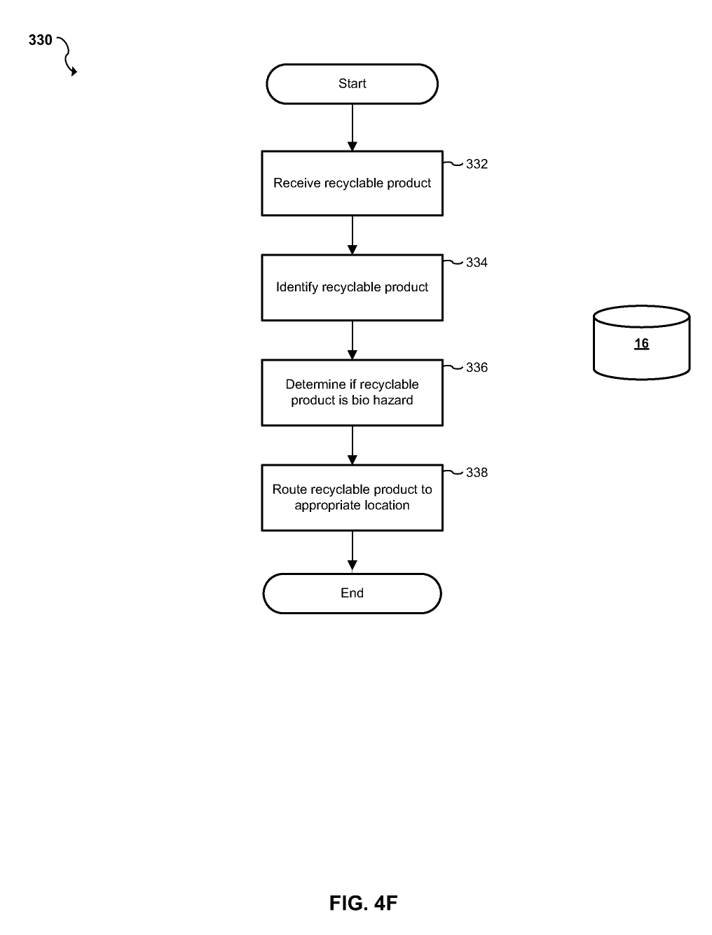

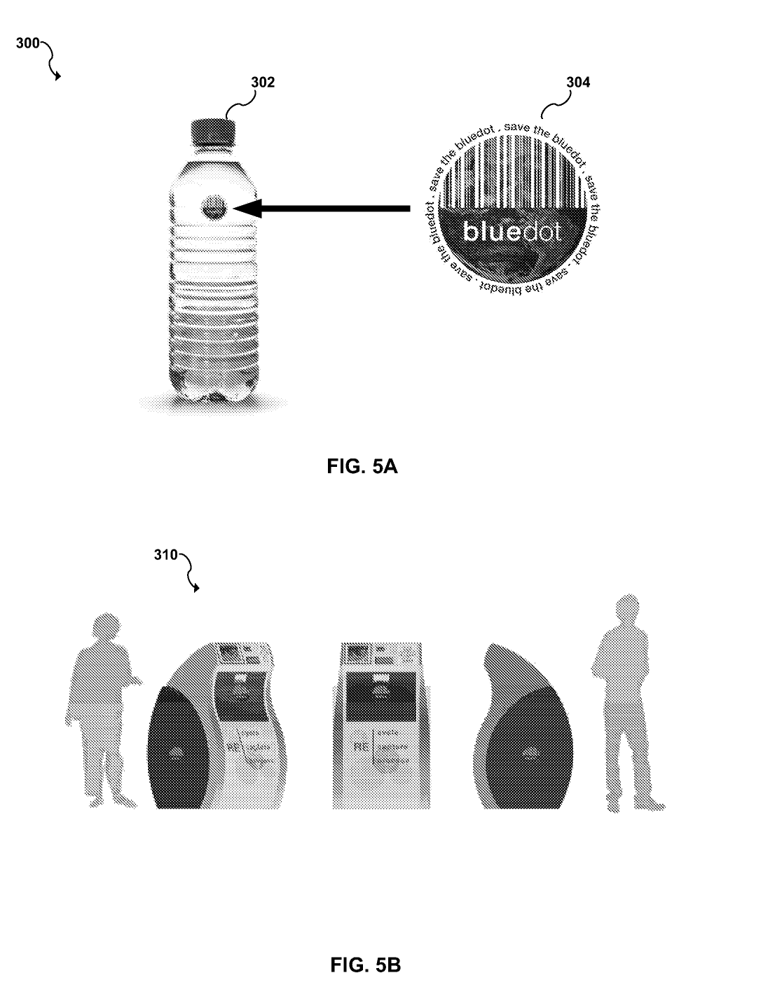

Referring to FIG. 4A, a flow chart illustrating a method for managing and tracking recyclable products in accordance with an embodiment of the present invention is shown. At block 202, a scannable unique identifier is added to a recyclable product during its manufacture or reprocessing. According to one embodiment, the unique identifier visually identifies the product as a recyclable product to a consumer, thereby encouraging the consumer to recycle to the recyclable product each time the recyclable product is viewed or used by the recycling user. In one embodiment, a bluedot symbol 304 as shown in FIG. 5A is added to a recyclable product 302. The bluedot symbol 304 not only visually identifies the product as a recyclable product, but also uniquely identifies the recyclable product such that it may be tracked during its recyclable lifecycle. However, it is understood that a visual identification of the product as a recyclable product is not required within the scope of the present invention and that any unique identifier may be used. For instance, the unique identification may be by means of a unique barcode, variable scan tracking symbol, tag, number, RFID or the like. According to at least one embodiment, the unique identifier is globally unique to all recyclable products. However, it is understood that such global uniqueness is not necessarily required under other embodiments of the present invention. For instance, it is understood that the unique identifier may be unique to a region, a classification, a product type, or the like, under alternative embodiments of the present invention.

At block 204, the unique identifier is associated with at least one entry in a database, such as database 16 in communication with server 14, as shown in FIG. 1. The recyclable product identifier may be scanned at one or more stages of the recyclable product's lifecycle, as shown at block 206. In one embodiment, the recyclable product identifier is scanned at each stage of the recyclable product's lifecycle. A recyclable product's lifecycle includes without limitation its manufacturing, storage, distribution, retail, recycling, and reprocessing stages. According to one embodiment, at one or more, or each, of these stages the unique identifier is scanned using a barcode or variable scan tracking symbol reader. According to other embodiments, the identifier is scanned using other scanning technologies, such as without limitation laser, x-ray, UV florescent or RFID scanning. The recyclable product's status is updated based upon scanned information and/or other information manually or automatically entered at block 208.

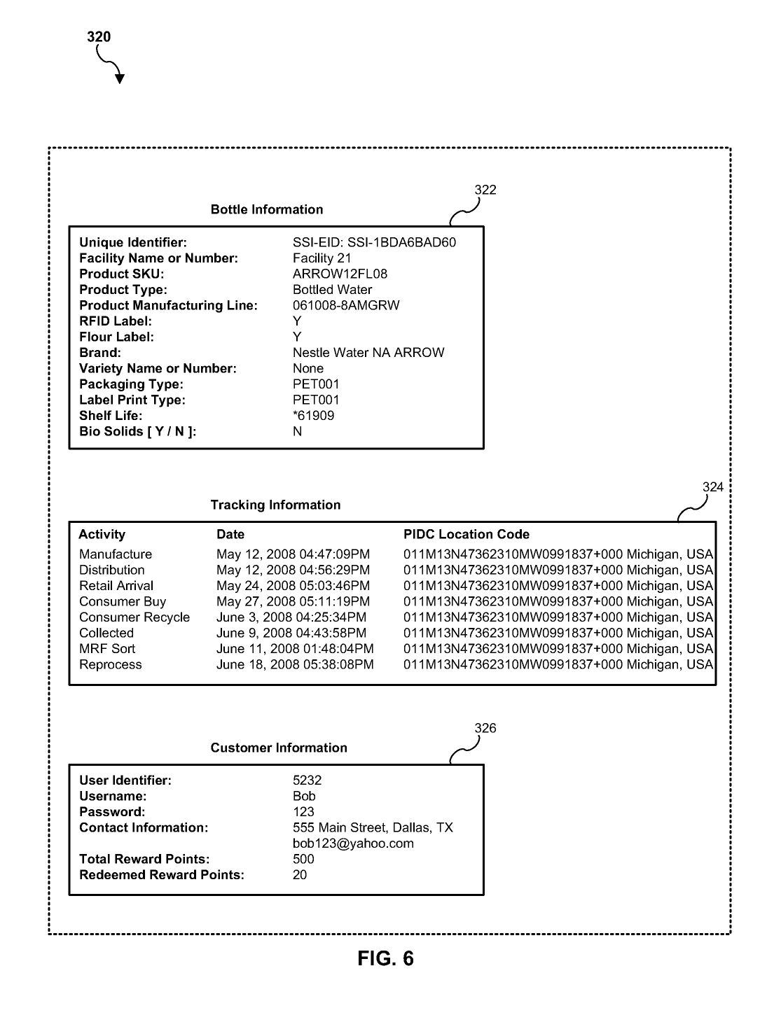

At block 210, information about the recyclable product is provided to a recycling user over a network, such as the Internet. In one embodiment, the information includes status information relating the stage of the recyclable product's lifecycle. As shown in table 424 of FIG. 6, the information may include tracking information, including without limitation the activity, date and PIDC location code. The PIDC location code is the product identification code and may be used to indicate where and when an event occurred within the recyclable product's lifecycle. As shown in table 422 of FIG. 6, the information may also include bottle information, including without limitation a unique identifier, a facility name and/or number, a product SKU, a product type, a product manufacturing line, an indication of whether the recyclable product includes an RFID label, a brand, a variety name and/or number, a packaging type, a label print type, a shelf life, and an indication of whether the product is a plastic, glass aluminum, or other type of material. The type of material indicates whether the product is a bio solid or a technical solid. For instance, fruit waste is a bio solid and plastic is a technical solid.

At block 212, the unique identifier is associated with a user identifier in a database. In one embodiment, unique identifier is associated with a user identifier in a customer information table. As shown in table 426 of FIG. 6, customer information includes without limitation a user identifier, a username, a password, contact information, a total number of reward points and a redeemed number of reward points. The unique identifier may be associated with a user without limitation when it is purchased by a consumer and scanned at a retail location, when it is returned by the consumer after consumer to a recycling center or station, when it is picked up from a recycling container during trash pickup, or when the recyclable product is otherwise recycled by the consumer.

In one embodiment, the recyclable product is scanned by a recycling user at a recycling center or station, during trash pickup, at a reprocessing location, at home or at a community location. The scanned information is used to identifying the product as a recycle product and to automatically segregate the recyclable products into separate bins or storage locations. Thereby, the amount of manual labor required during recycling and reprocessing may be reduced.

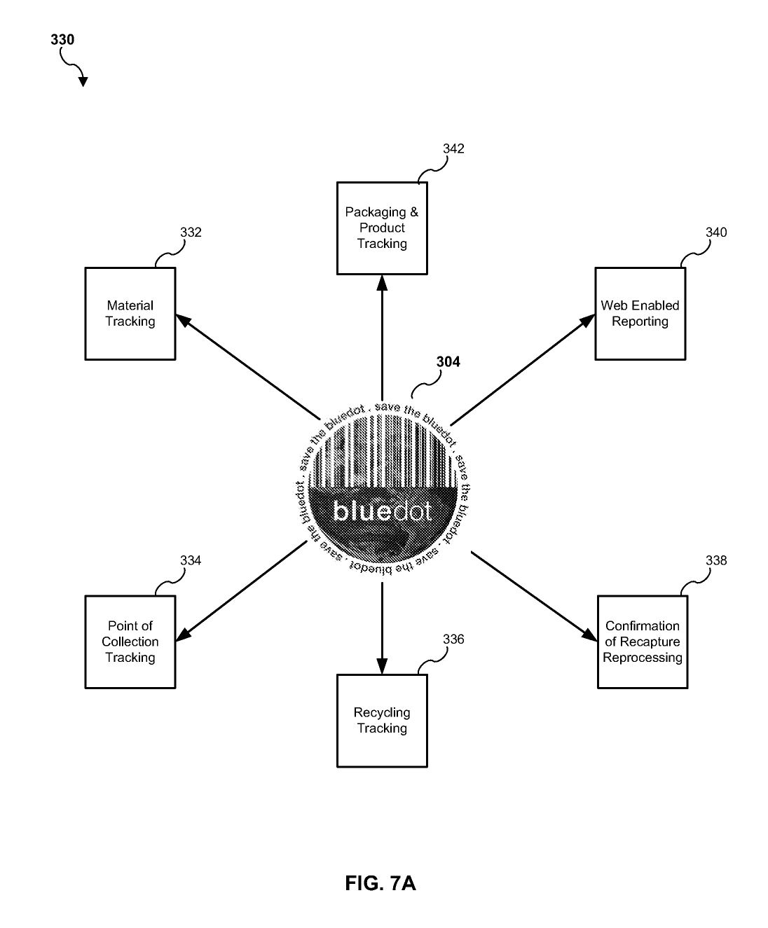

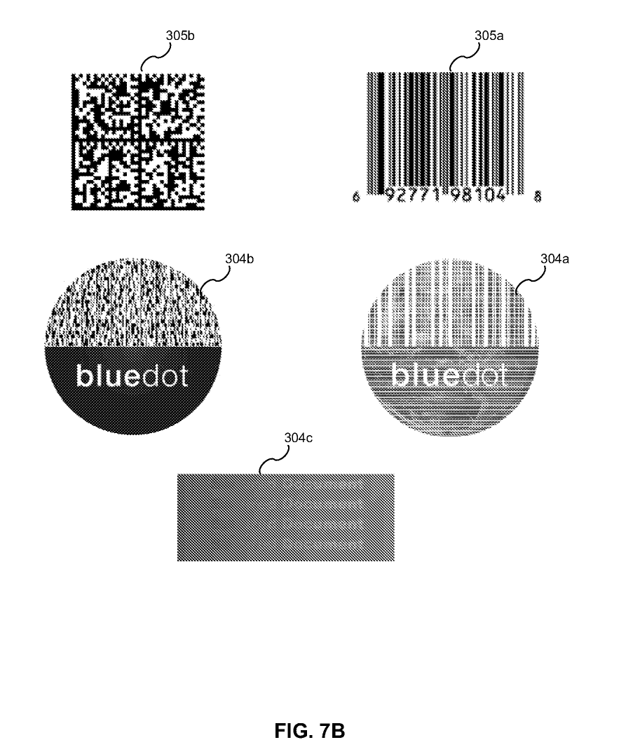

As shown in FIG. 7A, according to one embodiment the unique identifier 304 may be used for material tracking 432, point of collection tracking 434, recycling tracking 436, confirmation of recapture reprocessing 438, web enabled reporting 440, and packing and product tracking 442.

The present invention includes the capability to capture information associated with recyclable products, authenticate recyclable products, and prepare reports associated with the recyclable products. It uses encoding and decoding technologies to track recyclable products, recyclable product packaging and/or other materials after consumption. As previously described, encoding and decoding technologies may include a barcode, variable scan tracking symbol, tag, number, RFID or the like.

According to at least one embodiment, tracking is accomplished using a unique identifier affixed to packaging, products and/or materials associated with recycling. The unique identifier provides unique recognitions for the recyclable product, recyclable product packaging and/or other material that distinguishes it from the other similar items. The unique identifier may be affixed or marked on the packaging, product or material by any means known in the art. For instance, the unique identifier may be in the form of a 1-D or 2-D barcode, such as a 2-D data matrix barcode symbol, which is etched on a square grid. The marking may be either directly engraved on the packaging, product or material or affixed as labels or nameplates. However, preferably, the marking should be permanent for the lifetime of the recyclable packaging, product or material. However, it is understood that according to alternative embodiments, non-permanent marking may also be used. As is known in the art, two dimensional barcodes (also known as “2-D barcodes”) contain more information than conventional one dimensional linear barcodes (also known as “1-D barcodes”). 1-D barcodes typically get wider as more data is encoded. 2-D barcodes make use of the vertical dimension such that more data may be stored. 2-D barcodes are typically scanned using auto scanning CCD and laser scanners. These technologies may be incorporated into the unique identifier, including without limitation, unique identifiers 304a and 304b shown in FIG. 7B. Unique identifier 304a represents a 1-D barcode (305a represents a detailed portion of unique identifier 304a) and 304b represents a 2-D barcode (305b represents a detailed portion of unique identifier 304b). It is understood that any possible arrangement and configuration of barcode or variable scan tracking symbol is within the scope of the present invention. For instance, the unique identifier of the present invention is not limited to a circular barcode and may, instead, be any shape such as rectangular. Further, the unique identifier of the present invention is not limited to combination with an image, such as the bluedot earth image.

As shown in FIG. 7B, the unique identifier may utilize any encoding that provides a unique identification. For instance, without limitation, the unique identifier may use a variable code generated in a digital printing environment (304b), the unique identifier may be a UPC code generated in an offset printing environment (304a), the unique identifier may be an invisible fluorescent stripe generated in an offset printing environment (304c), the unique identifier may be a unique image or picture (not shown), and the like.

According to one embodiment, variable 2-D encoding may be used to track the product life of a packaging, product or material associated with recycling. Alternatively, 1-D UPC encoding may be used to track the product life of a packaging, product or material associated with recycling using that recyclable product's SKU (an abbreviation for “stock keeping unit”), which is a number or string of alpha or numeric characters that unique identify a product. As is known in the art, a UPC (an abbreviation for “universal product code”) is a barcode symbology that is widely used in the United States and Canada for tracking items. SKUs are typically universal numbers, such as a UPC code or supplier part number, or may be a unique identifier used by a specific store, retailer or manufacture.

According to at least one embodiment, at some point during the life cycle of the packaging, products and/or materials associated with recycling, a unique identifier is affixed or marked on the recyclable product, recyclable product packaging and/or other material by any means known in the art. Typically, this occurs during the manufacture or re-manufacture stage for the packaging, product or material. However, such marking is not limited to such stages and may also occur during other stages of the product's lifecycle, such as upon arriving at a store or retail location or a distribution center. The present invention includes a database configuration which can be integrated to other segments of a value chain, including, without limitation, from primary manufacturing to secondary re-manufacturing.

The database is accessible over via a network, such as the Internet, Intranet or propriety network. At some point during the life cycle of the packaging, products and/or materials associated with recycling, the unique identifier for such item is stored in the database along with other relevant data associated with such item. Typically, this occurs during the manufacture or re-manufacture stage for the packaging, product or material. However, such marking is not limited to such stages and may also occur during other stages of the product's lifecycle, such as upon arriving at a store or retail location or a distribution center. Alternatively, this may also occur when the packaging, product or material is scanned upon purchase by a consumer or when the item is presented for recycling at a recycling center or station, such as a tracking station, remote kiosk, reverse vending machine and the like. In either case, hardware and software components, such as a barcode scanner, network interface and associated software, are provided such that the unique identifier may be scanned by the manufacturer, retailer, consumer and/or recycling user, and the unique identifier is communicated over the network interface to the database and stored in the database. Such scanning may occur at multiple stages of the product's lifecycle. Other data associated with the packaging, product or material may also be communicated to the database, such as without limitation the type of packaging, product or material, the current stage in the lifecycle of such item via one or more graphical user interfaces.

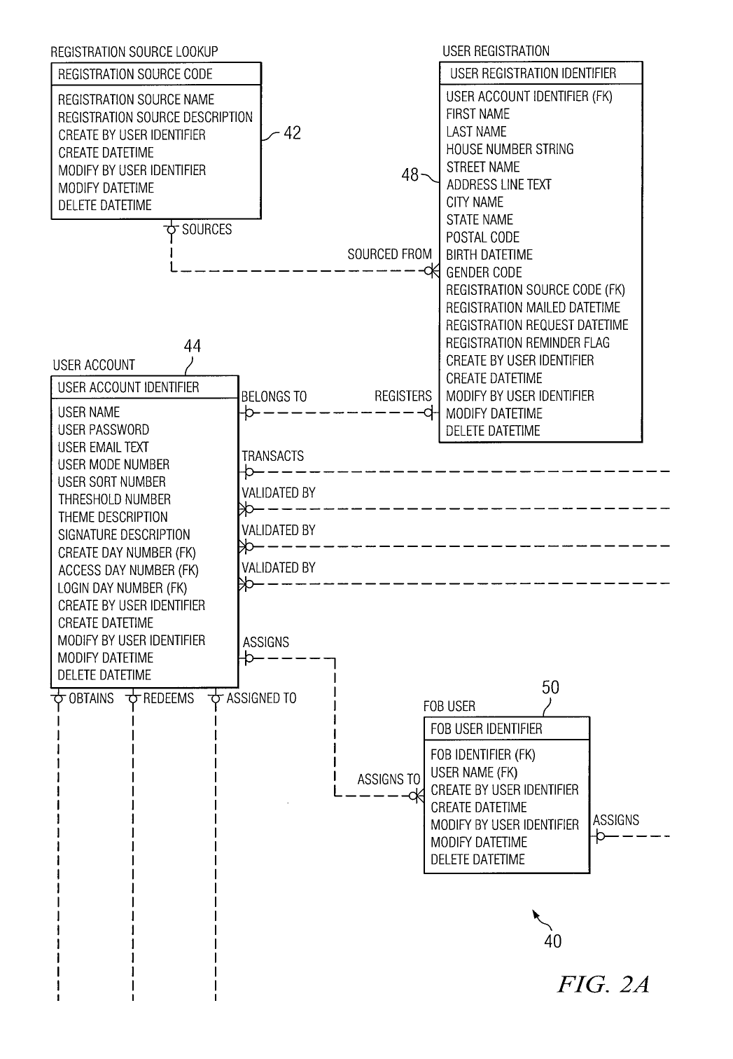

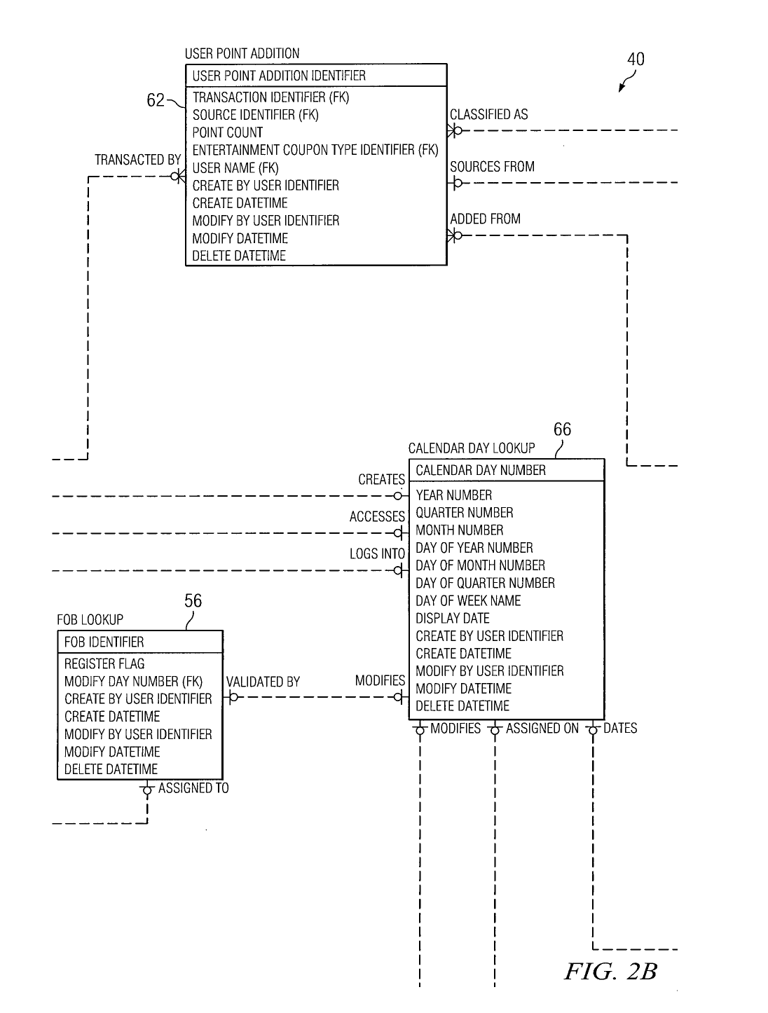

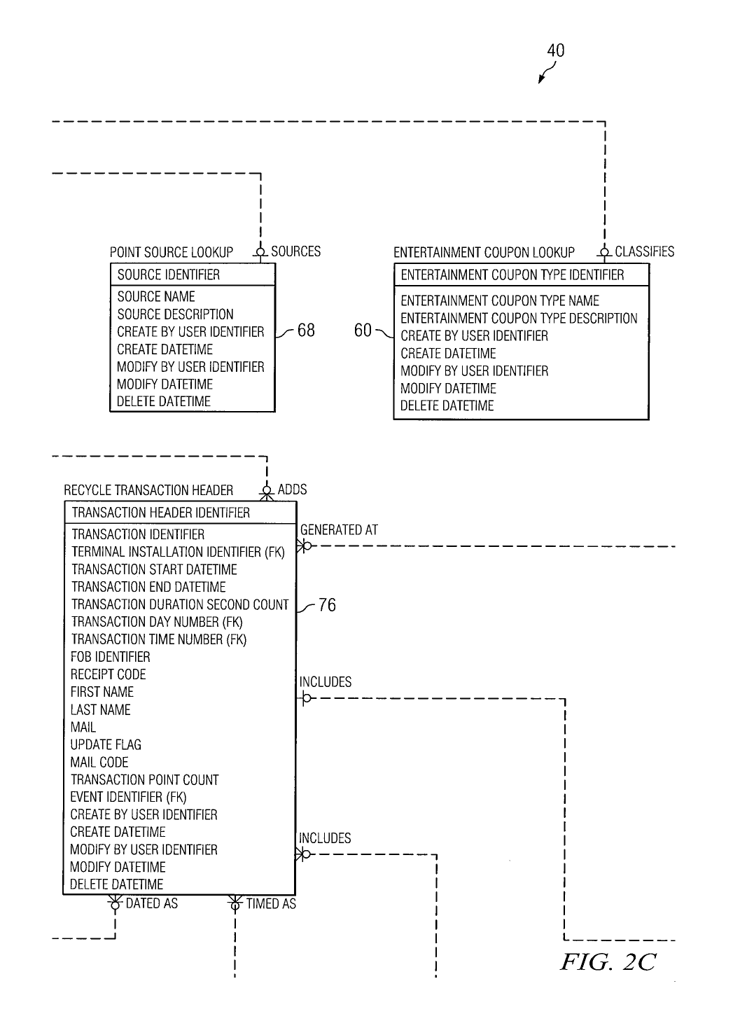

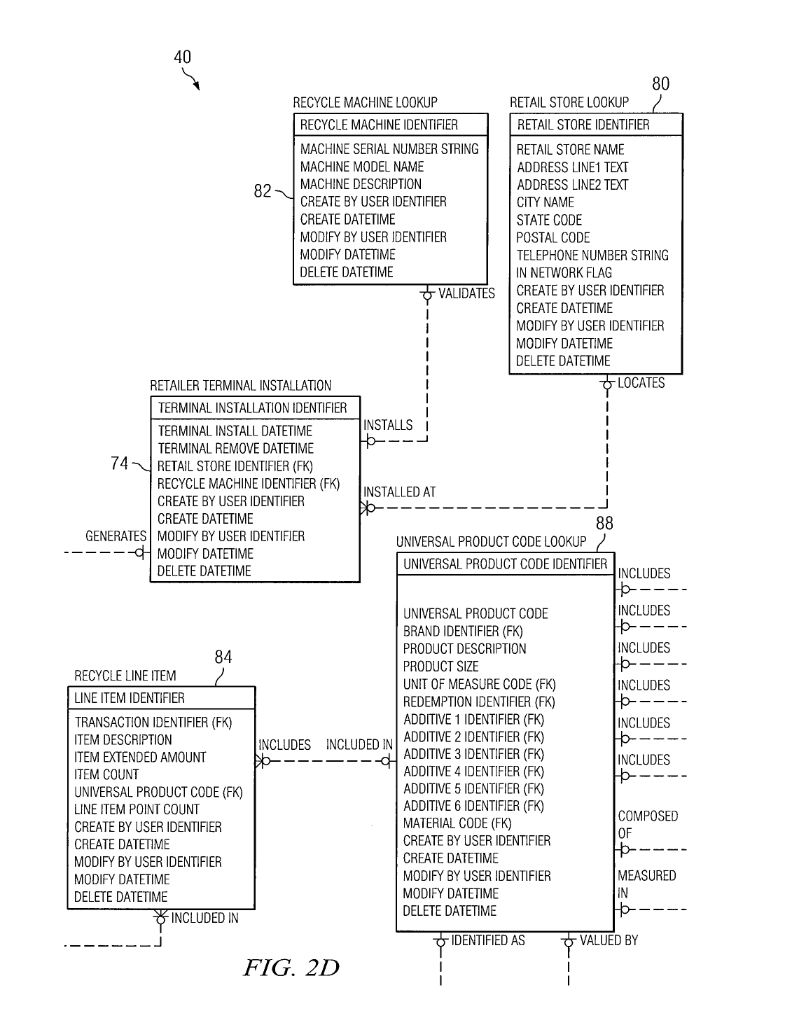

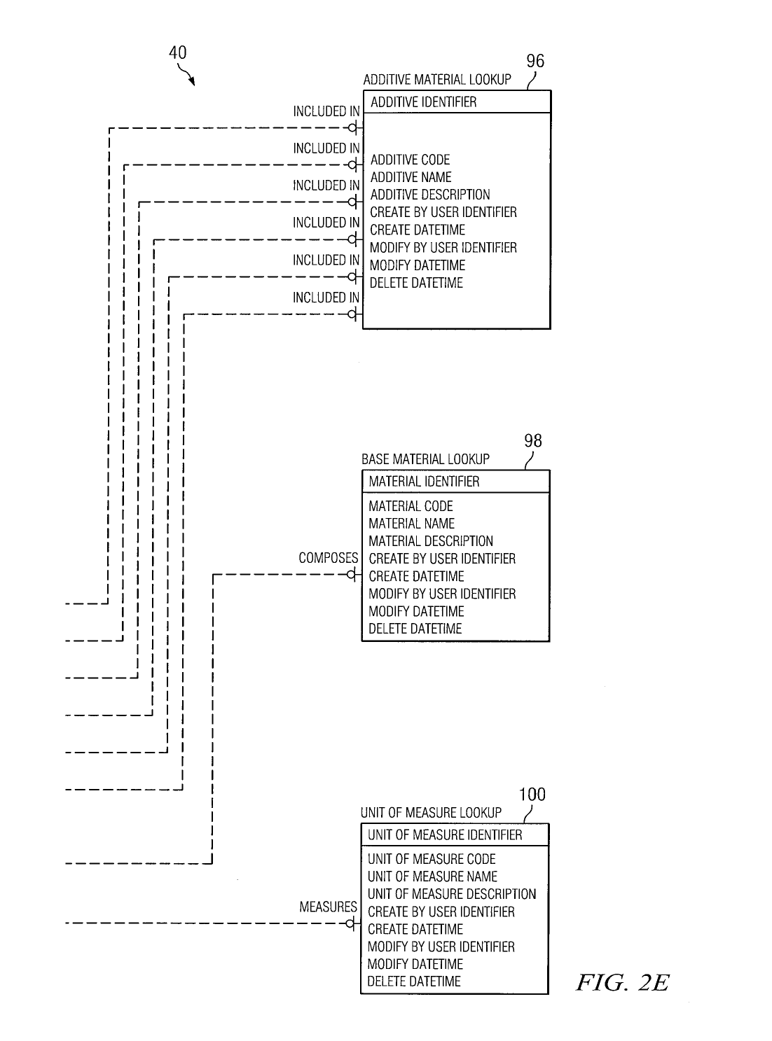

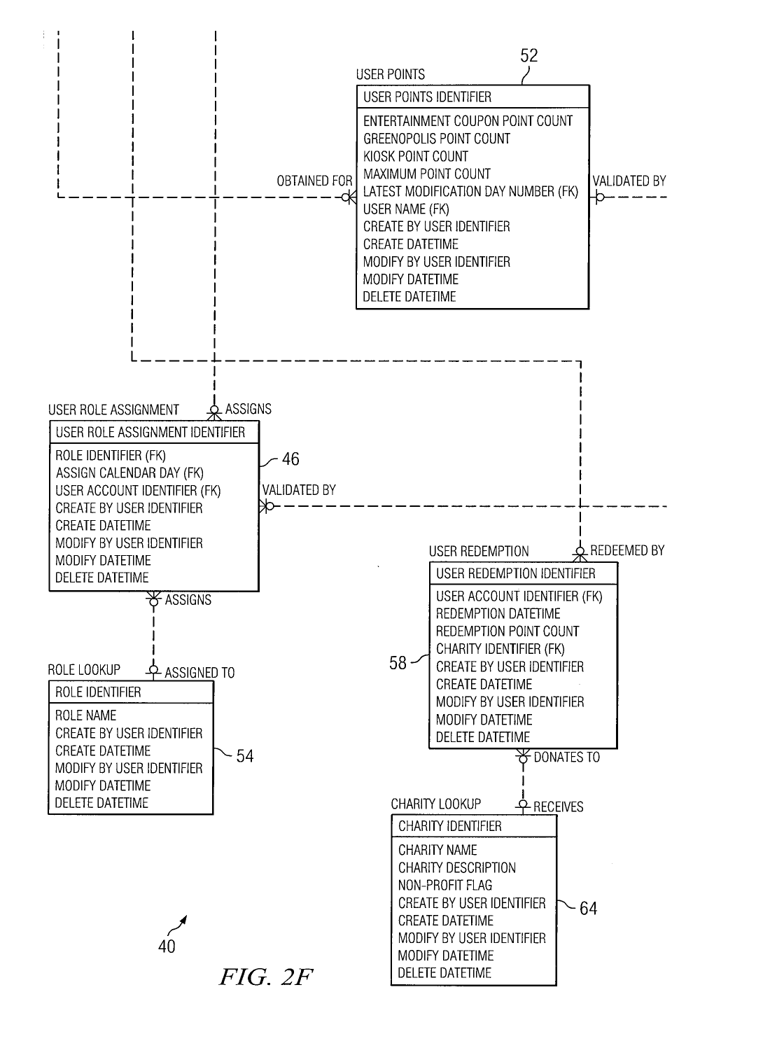

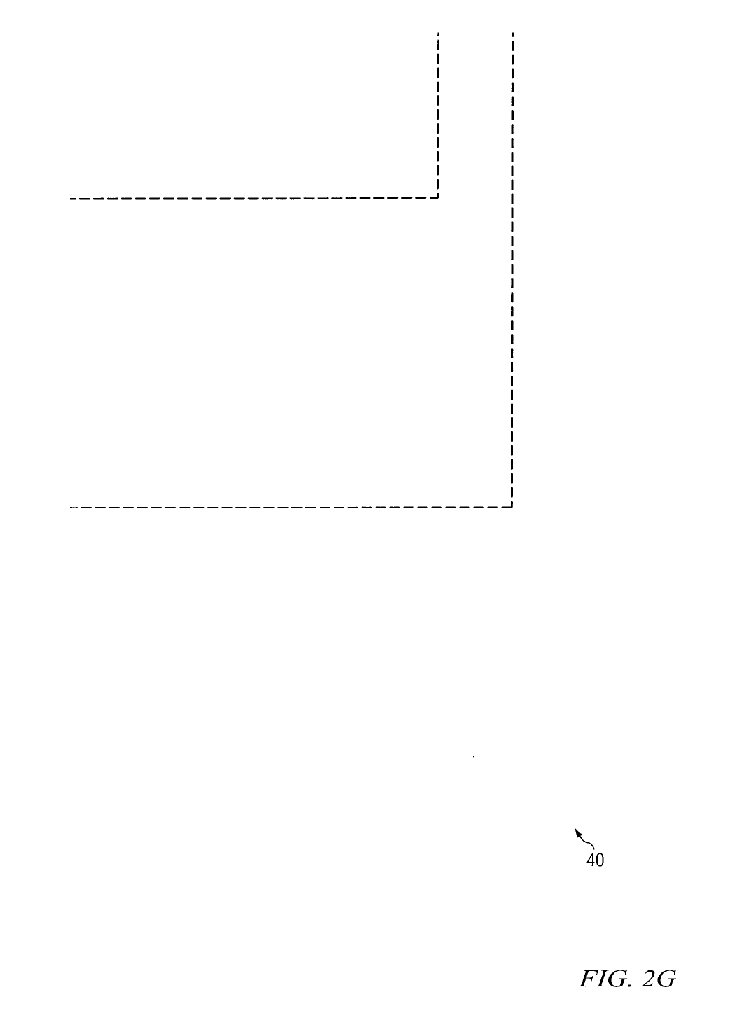

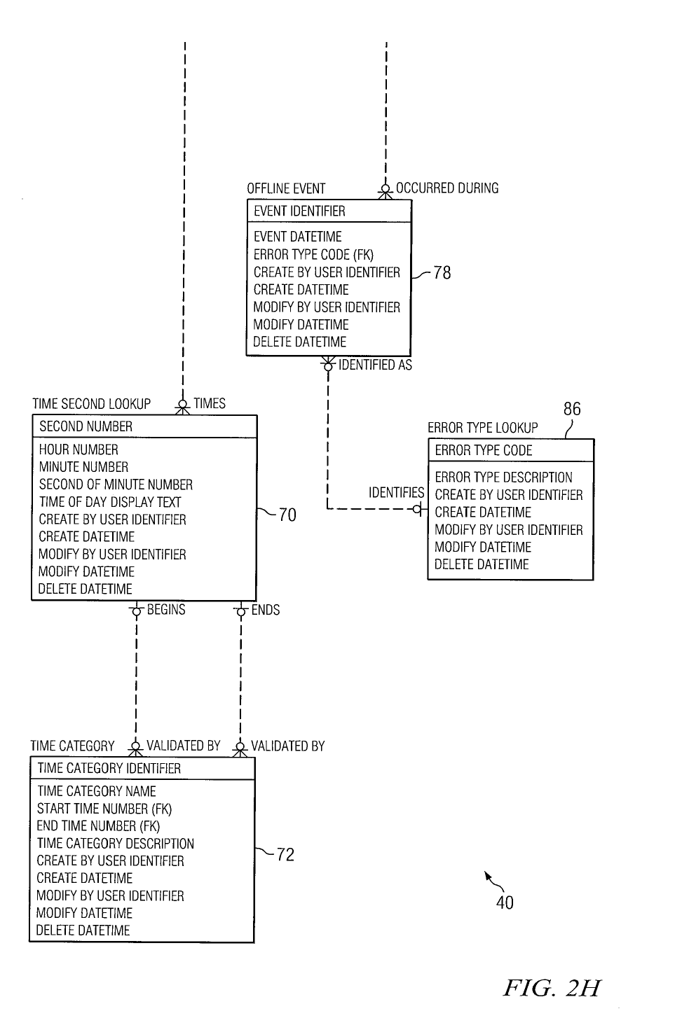

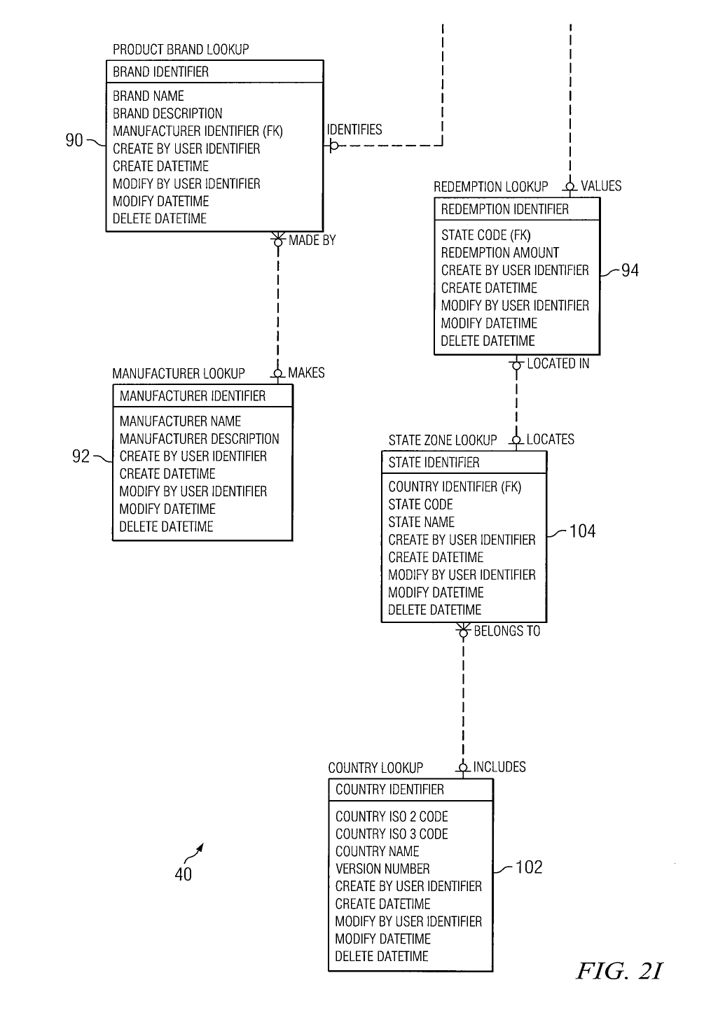

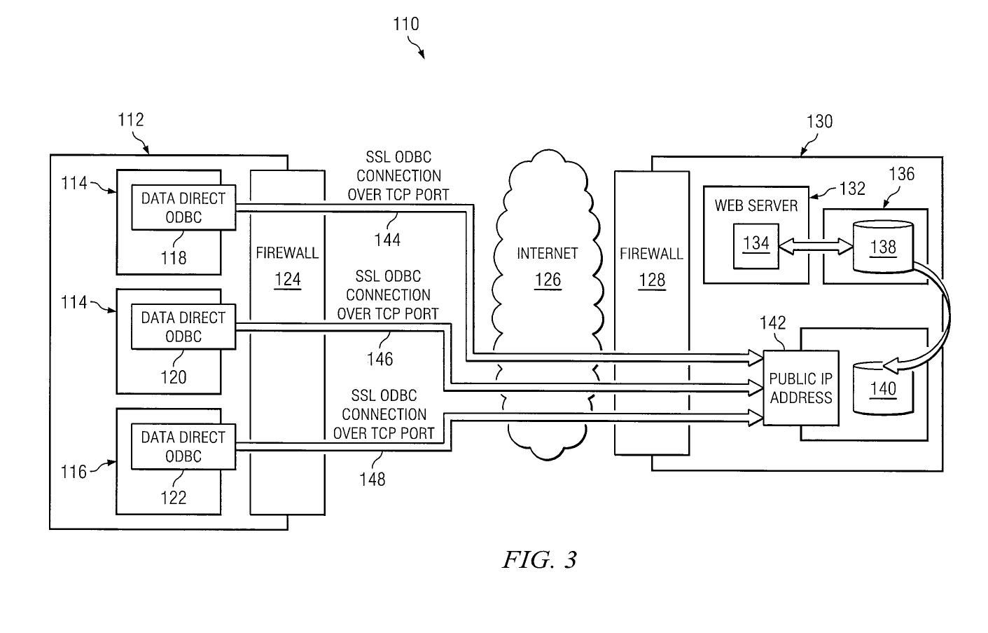

Referring to FIGS. 2A-2I, block diagrams illustrating an exemplary database schema associated with a recycling enterprise in accordance with an embodiment of the present invention are shown. Utilizing the database tables shown in FIGS. 2A-2I, the operation of a recycling enterprise may be greatly improved. According to one embodiment, the database at least includes without limitation user account table 44, user registration table 48, user points table 52, and user redemption table 58. User account table 44 includes information about the recycling user. The recycling user is typically associated with a key FOB via FOB lookup table 56. User registration table 48 includes information about a recycling user that has registered his/her information for instance using the GreenOps website. User points table 52 includes various point information associated with the recycling user. User redemption table 58 includes information regarding the redemption activities of the recycling user, such as when the redemption occurred.

The database also includes information about the recyclable product. For instance, universal product code table 88 includes UPC information relating to a recyclable product, such as without limitation, a unique identifier, the brand of recyclable product, the type of material the recyclable product, the recyclable product manufacturer, and when the recyclable product was created. Recycle line item table 84 includes information about individual recyclable products recycled at, for instance, a recycling center or station. Retail store lookup table 80 includes information about the retail store where the recyclable product was recycled.

### II. Rewards Program

The present invention also encourages consumers to recycle, improves automation and reduces manual labor associated with recycling. Thereby, the amount of material recycled and reprocessed is increased. According to at least one embodiment, the unique identifier is associated with a particular user, such as the recycling user for purpose of providing a reward for the recycling activities of such user.

Referring to FIG. 4C, a flow chart illustrating a method for maintaining a rewards program in accordance with an embodiment of the present invention is shown. At block 242, a new account is registered for a recycling user. According to one embodiment, a recycling user may register a new account by accessing a web server using a web browser over a network and entering user information. Alternatively, the new account is registered by a server administrator. The recycling user is associated with a database entry on a server at block 244. According to one embodiment, a unique user identifier identifies one or more database records that contain information associated with the recycling user, information about the recycling user's activities, and reward points associated with the recycling user. At block 246, reward points are updated based on the recycling user's recycling activities or other activities. For instance, reward points are earned by the recycling user for depositing recycling products in a recycling center or station or for participating in a recycling home pickup program. Reward points may also be earned by the recycling user for participating in an environmentally focused website, listserv or blog, and the like. The reward points may also be earned by the recycling user for other activities that encourage recycling generally or are environmentally focused.

The reward points are redeemed upon demand by the recycling user at block 248. According to one embodiment, a recycling user logs in to a web server using a web browser using a username and password. At block 250, the reward points are monitored, printed, or transferred upon demand by the recycling user. The recycling user may also monitor the recycling activities associated with the recycling user. According to one embodiment, a recycling user may manage reward points, including without limitation monitoring, printing or transferring reward points, by accessing a web server using a web browser over a network. According to an alternate embodiment, the recycling user may manage reward points using a graphical user interface located on a recycling center or station.

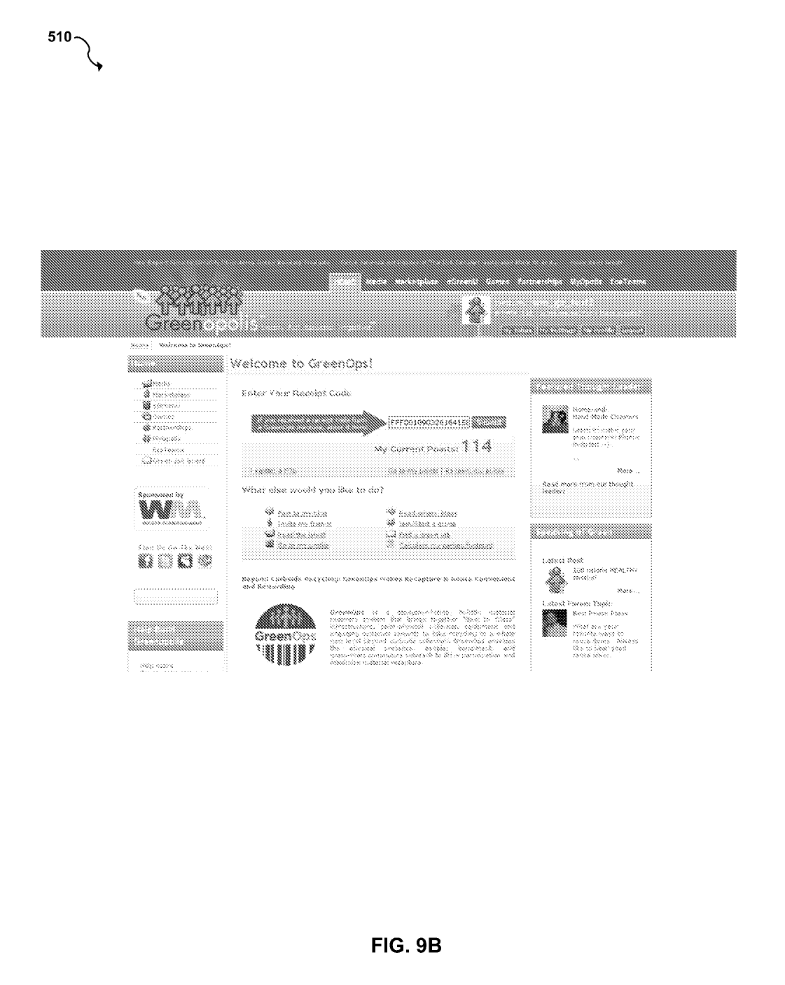

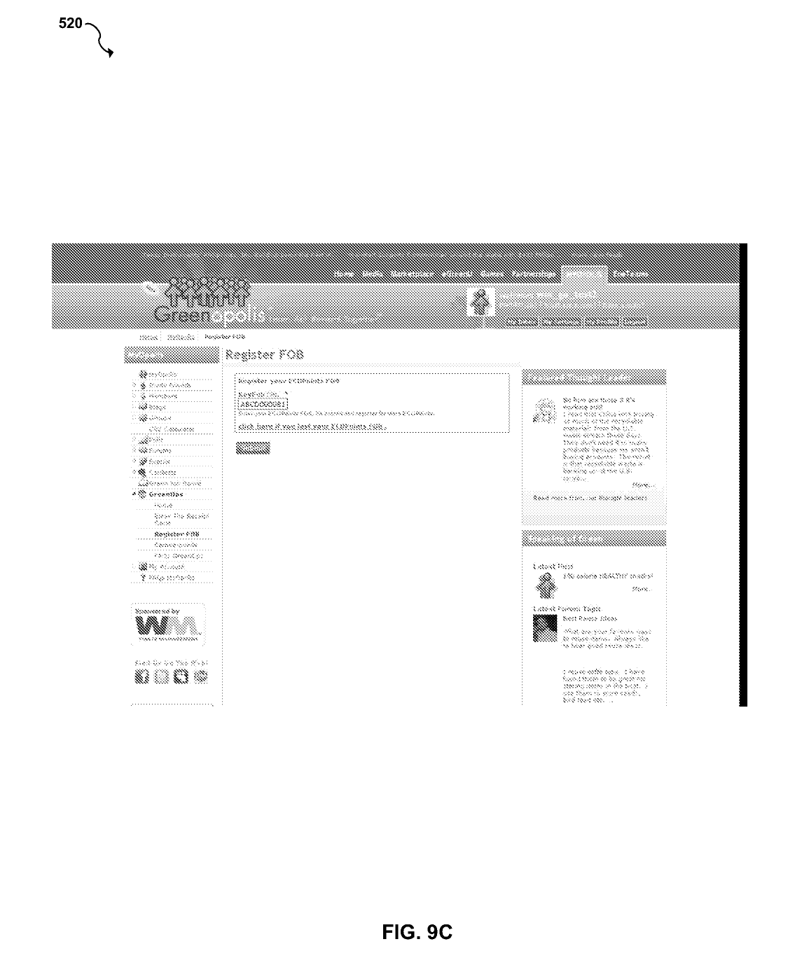

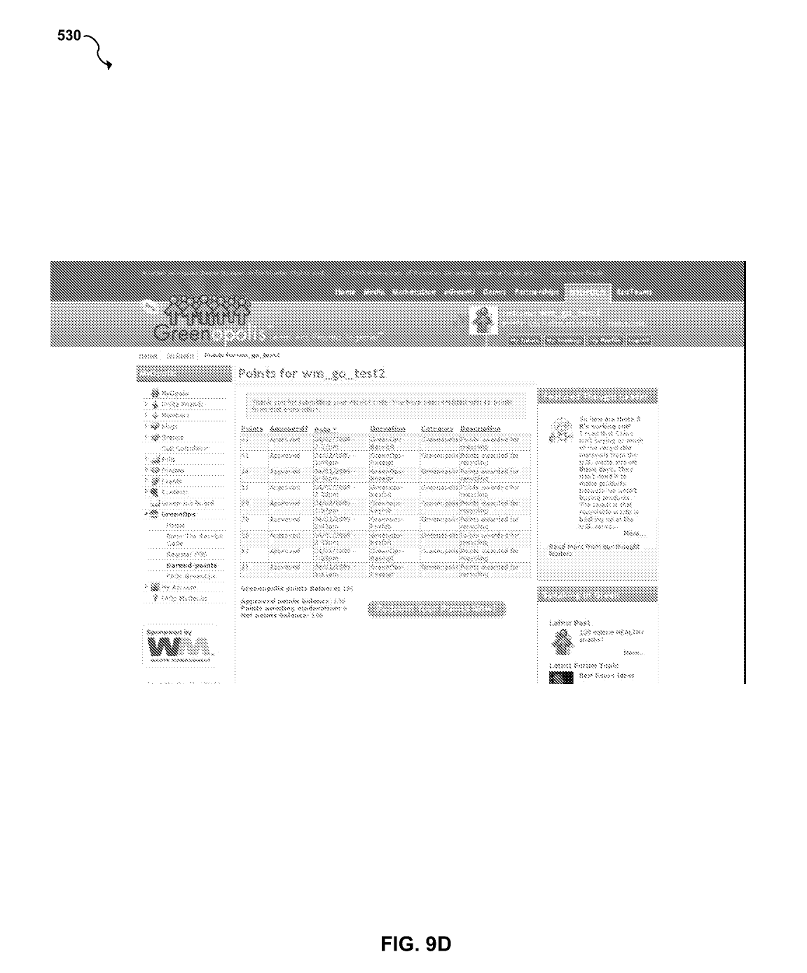

Referring to FIGS. 9A-9D, block diagrams illustrating one possible implementation of a web-based interface in accordance with an embodiment of the present invention are shown. According to this embodiment, a recycling user logs in to a web server using a web browser using a username and password, as shown in FIG. 9A. The recycling user may manually enter recycling activities associated with the recycling user by entering a receipt code provided at the recycling center or station, as shown in FIG. 9B. If the recycling user has a key FOB, then the recycling user may register the key FOB on the web-based interface, as shown in FIG. 9C. Once the key FOB is registered, any recycling activities associated with the key FOB will automatically be entered for the recycling user. The recycling user may review recycling activities associated with the recycling user and may redeem points associated with the recycling activities, as shown in FIG. 9D.

### III. Recycling Center or Station

The present invention includes a recycling center or station, such as a tracking station, remote kiosk, reverse vending machine and the like, that is designed to be visually engaging to consumers and/or recycling users. The recycling center or station is designed to be easy to use for consumers and/or recycling users and includes multiple marketing and communications opportunities for retailers and brands. The recycling center or station includes one or more receptacles configured to receive the recyclable product. According to at least one embodiment, multiple receptacles are arranged on the recycling center or station to receive different types of recyclable products, such as without limitation, glass, plastic, or metal recyclable products. According to at least one embodiment, the recycling center or station includes a scale to weigh the recyclable product.

The recycling center or station may include a scan engine that is configured to be used by end consumers, and/or by non-consumers, such as manufacturers, re-manufacturers, retailers, and the like for internal purposes. According to at least one embodiment, the engine kernel of the non-consumer configuration may include consumer shells or interfaces as enhancements for public use.

The present invention includes flexible software and hardware components that can interface with consumers at retail or support industrial applications. These software and hardware components were designed to increase recycling and reprocessing rates of any material stream that uses coding mechanisms and support industrial control systems to sort materials in a deeper manner to potentially create cleaner and higher value materials streams for enhanced reprocessing and reuse. According to at least one embodiment, the software and hardware components include a graphical user interface accessible to retailers, manufacturers, consumers and/or recycling users that may be used to track the stage of the item or provide other information relevant to such item. According to other embodiments described below, the user may also access the graphical user interface at a recycling center or station, such as a tracking station, remote kiosk, reverse vending machine and the like. The graphical user interface may be used to display information about the recycling activity and/or otherwise communicate with the recycling user.

According to at least one embodiment, the recycling center or station includes the ability to identify the recyclable product. Such identification may be by means of scanning a unique barcode, tag, number, RFID or the like, on the recyclable product. Such identification may also be by other means such as the product weight.

The recycling center or station may optionally include one or more cameras or other optical devices. The one or more cameras may be used to capture an image of the recyclable product. The captured image may be processed in near real-time in order to identify the type of recyclable product using fuzzy logic to match images of known products stored in a database with the captured image. For instance, this technique may be used where the unique identifier has been removed or is obscured and is unable to be scanned normally. According to one embodiment, the captured image may be used to verify the type or number of recyclable products. Alternatively, a captured image of the recyclable product may be stored in a database and associated with the unique identifier.

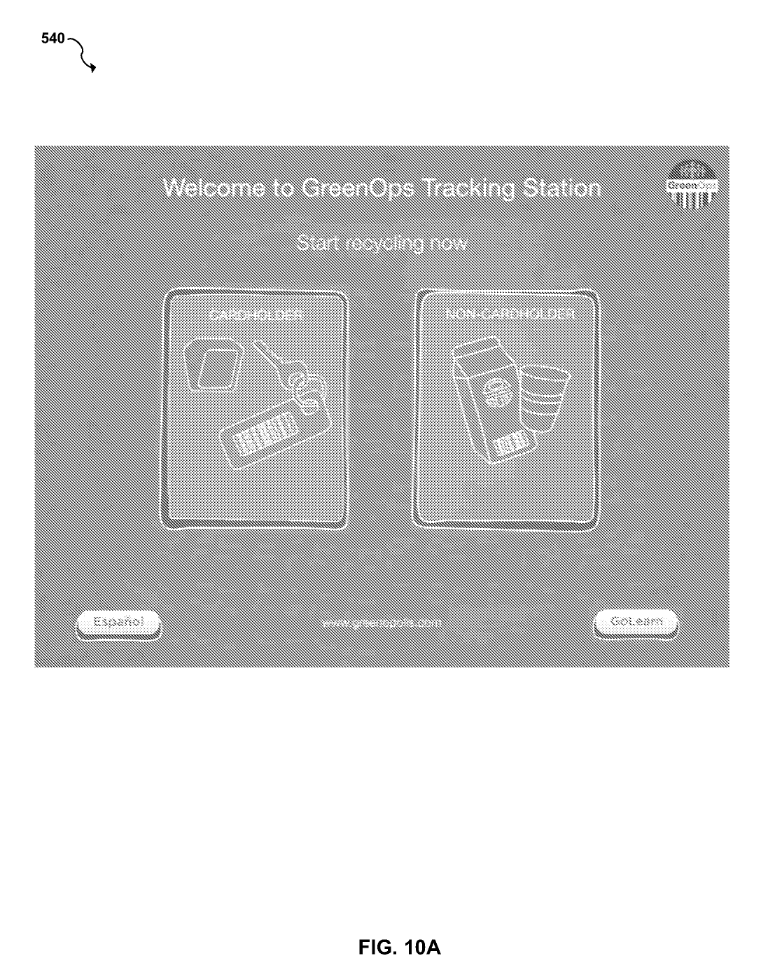

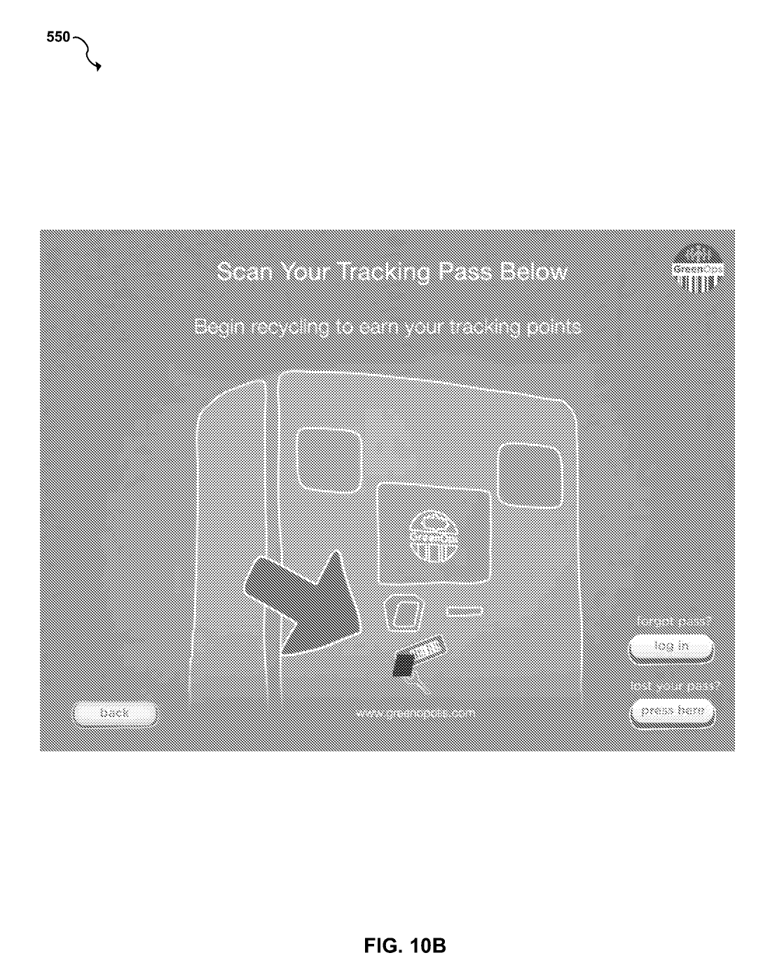

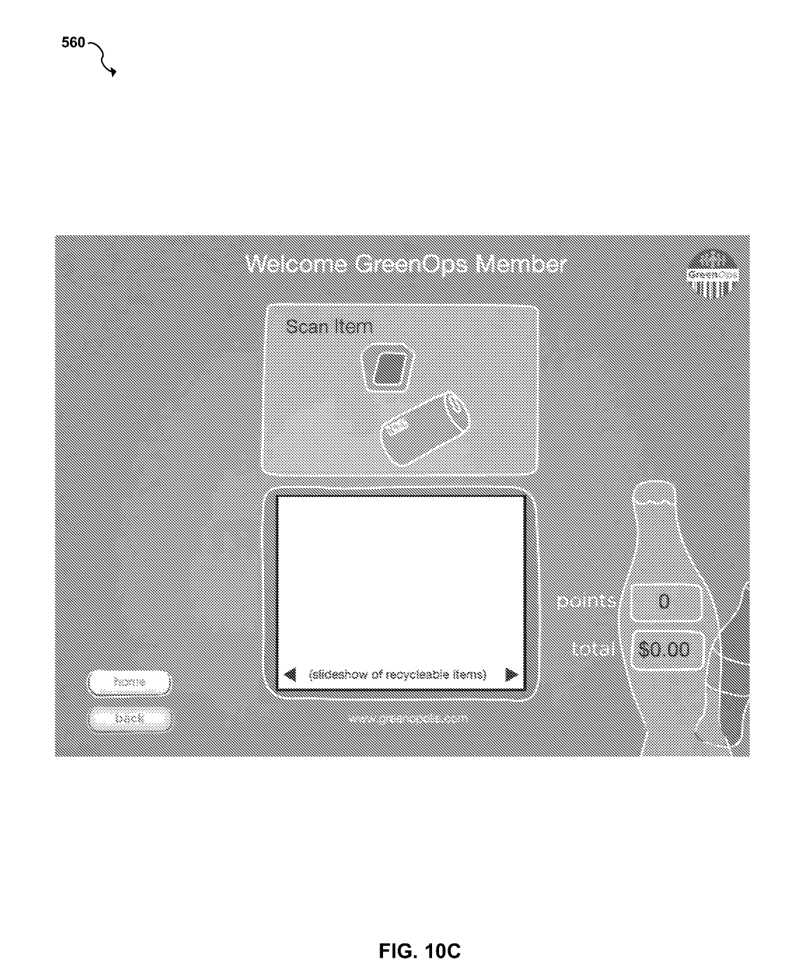

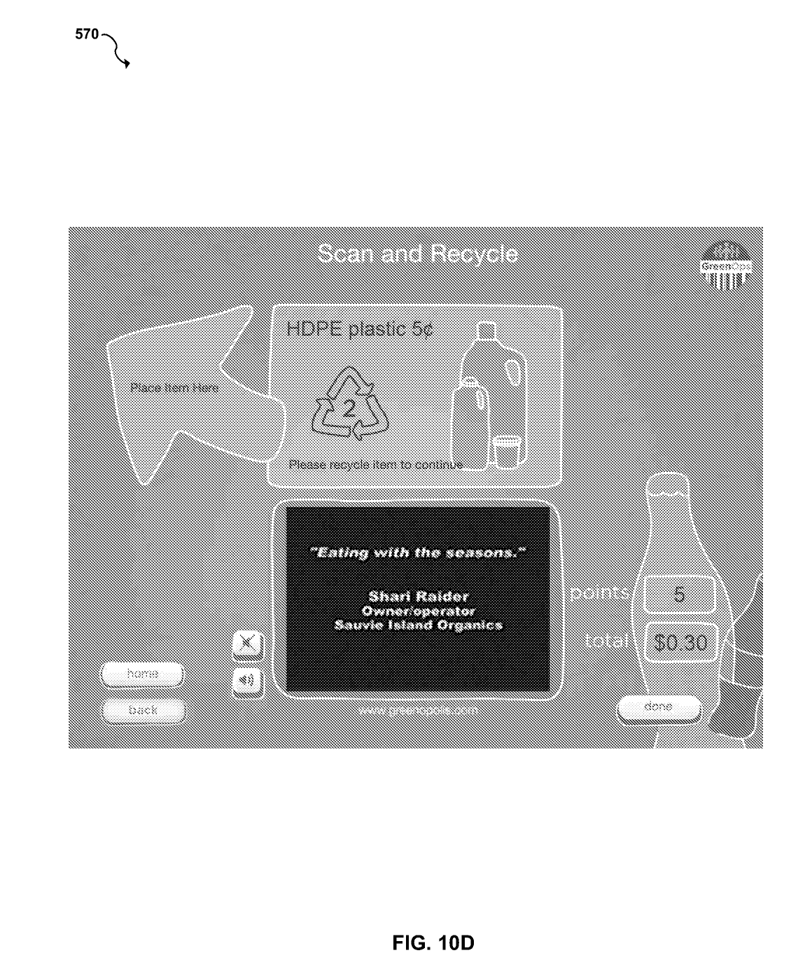

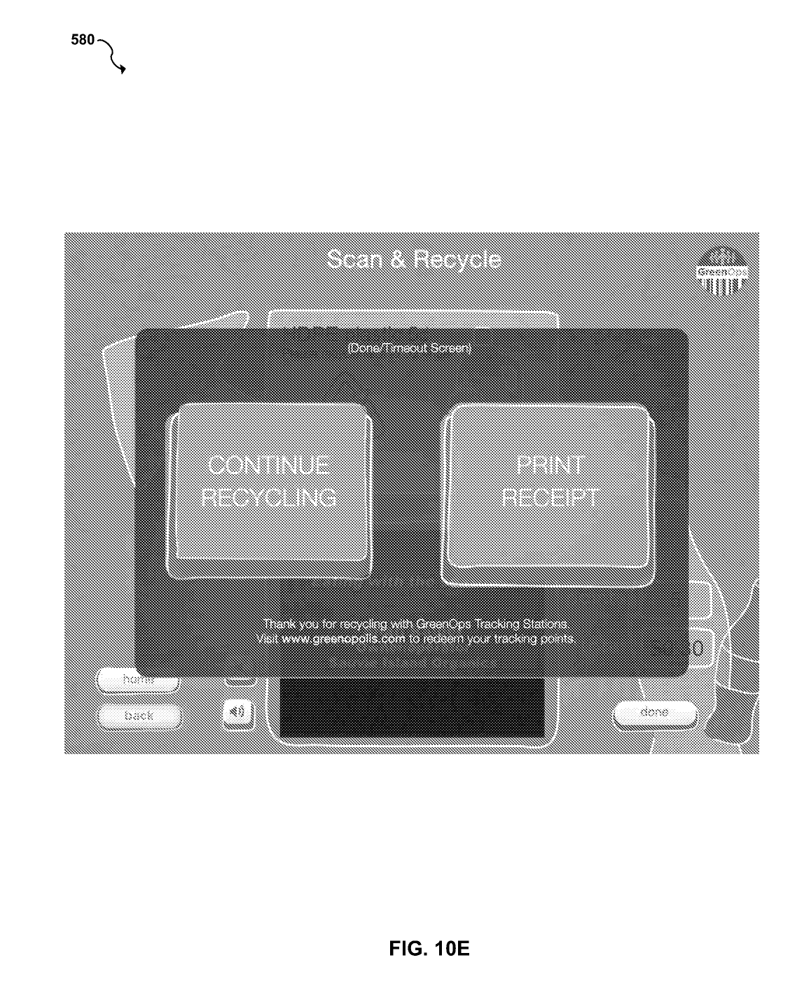

Referring to FIGS. 10A-10E, block diagrams illustrating one possible implementation of a recycling center or station interface in accordance with an embodiment of the present invention are shown. According to this embodiment, a recycling user may either access the recycling center or station as a card holder or a non-cardholder, as shown in FIG. 10A. If the recycling user is accessing the recycling center or station as a card holder, then the recycling user is prompted to scan a key FOB associated with the recycling user, as shown in FIG. 10B. The recycling user scans one or more recyclable products using the interfaces shown in FIGS. 10C-10E. The recycling user may print a receipt of the recycling user's recycling activities, as shown in FIG. 10E.

### IV. Gotracker

The present invention includes a tracking module that allows a recycling user to track recycling activities at recycling center or station, such as a tracking station, remote kiosk, reverse vending machine and the like, at home or in other recycling environments. According to at least one embodiment, the tracking module is implemented as a mobile device software application. The mobile device software application may be configured to run on any mobile device, such as without limitation, an Apple iPhone, a Google Google G! Phone, a Blackberry phone, a Palm Treo, or any other portable computing device, such as a general cell phone or a PDA. The mobile device software application is available for download from an app store, a web site or other electronic means. The mobile device software application is configured to operate using any known communication system, other systems, cell networks and the like.

The tracking module provides support for a displaying or otherwise communicating a unique identifier, including without limitation, an RFID, a virtual key fob, an image, a number or a barcode. The image, number or barcode may be displayed on a graphical display of the mobile device. According to one embodiment, the barcode represents a universal product code (UPC). The unique identifier may be used by a recycling user to identify the user, at home, at retail locations and/or during recycling activities at home or a recycling center or station, such as a tracking station, remote kiosk, reverse vending machine and the like. The virtual key fob or UPC barcode may be used by a recycling user to engage consumers and initiate user activity at a recycling center or station. The barcode can also be used for use at a recycling center or station or at retail locations for purposes of loyalty and discount value programs.

As is well known by those of ordinary skill in the art, a key fob is a small hardware device with a built-in authentication mechanism. Just as the keys held on an ordinary key chain provide access to the owner's home or car, the mechanisms in the key fob control access to services and information. Key fobs and other devices, such as smart cards, provide authentication which authenticates the user as the device's owner. The key fob may require the user to provide a personal identification number (PIN), which authenticates them as the device's owner; after the user correctly enters their PIN, the device displays a number which allows them to access services.

According to at least one embodiment, a recycling user is associated with a unique UPC barcode. According to one possible implementation, the recycling user logs in over a network to a server having access, either directly or indirectly, to a plurality of high-resolution UPC barcode images. The recycling user logs in to the server using a username and password, or other security mechanism. A personal high-resolution UPC barcode image is then downloaded and the tracking module displays a personal high-resolution UPC barcode image on the screen of a mobile device. The mobile device may be without limitation an Apple iPhone, a Google Google G! Phone, a Blackberry phone, a Palm Treo, or any other portable computing device, such as a general cell phone or a PDA. Alternatively, the recycling user downloads the tracking module as an application, such as via an app store, a web site or other electronic means, and the tracking module downloads the high-resolution UPC barcode image.

According to an alternative embodiment, a recycling user is associated with a unique virtual key fob. According to one possible implementation, the recycling user logs in over a network to a server having access, either directly or indirectly, to a plurality of virtual key fob data. The recycling user logs in to the server using a username and password, or other security mechanism. The virtual key fob data is then downloaded and the tracking module communicates information as virtual key fob using the communication capabilities present on a mobile device.

Referring to FIG. 4B, a flow chart illustrating a method for tracking recyclable users in accordance with an embodiment of the present invention is shown. At block 222, a user identifier is assigned to a recyclable user and stored in database 16 on sever 14. The user identifier includes without limitation a unique database key field in a database table. The user identifier is associated with a portable identifier at block 224. Portable identifiers include without limitation images, numbers, codes, barcodes, RFIDs, virtual key fob codes, or the like. The portable identifier may be generated upon demand. At block 226, information associated with the portable identifier is stored in a database record associated with the user identifier. This information may include the mobile identifier itself, or other information associated with, or used to retrieve, the mobile identifier. A tracking module is downloaded to a mobile device at block 228. This download may be accomplished by any means including without limitation a recyclable user logging in to a server and selecting to download the tracking module over a network. Downloading the tracking module may include downloading the mobile identifier that is associated with the recyclable user. Alternatively, the mobile identifier may be downloaded over a network separately or via a different server. At block 230, the tracking module is executed on the mobile device. The tracking module either displays the mobile identifier on the display of the mobile device or otherwise communicates the mobile identifier using the communication capabilities of the mobile device at block 232. At block 234, the mobile identifier is scanned or otherwise received by a recycling center or station, and the recycling user is identified by locating the user identifier associated with the portable identifier in the database. The recycling activity associated with the recycling user is tracked using the user identifier at block 236. Thereby, the recycling activities of the recyclable user may be tracked without requiring the recyclable user to manually enter an identifier.

### V. Goscan

The present invention includes a scanning module that allows a recycling user to scan and review recycling activities from home and to engage consumers and initiate user activity at retail locations, at recycling centers or stations, at home or in other recycling environments. According to at least one embodiment, the scanning module is implemented as a mobile device software application. The mobile device software application may be configured to run on any mobile device, such as without limitation, an Apple iPhone, a Google Google G! Phone, a Blackberry phone, a Palm Treo, or any other portable computing device, such as a general cell phone or a PDA. The mobile device software application is available for download from an app store, a web site or other electronic means. The mobile device software application is configured to operate using any known communication system, other systems, cell networks and the like.

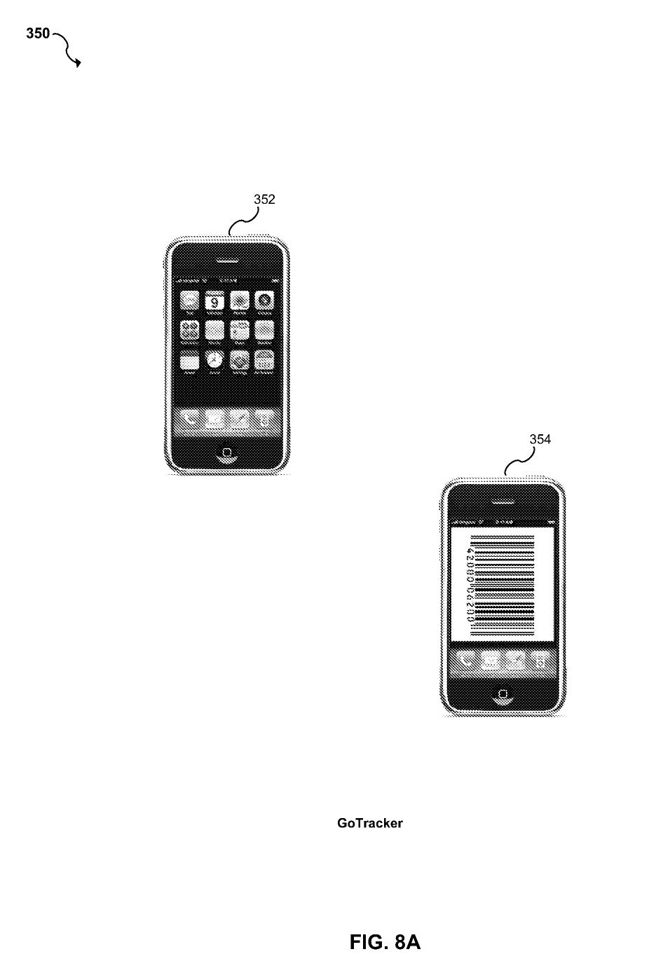

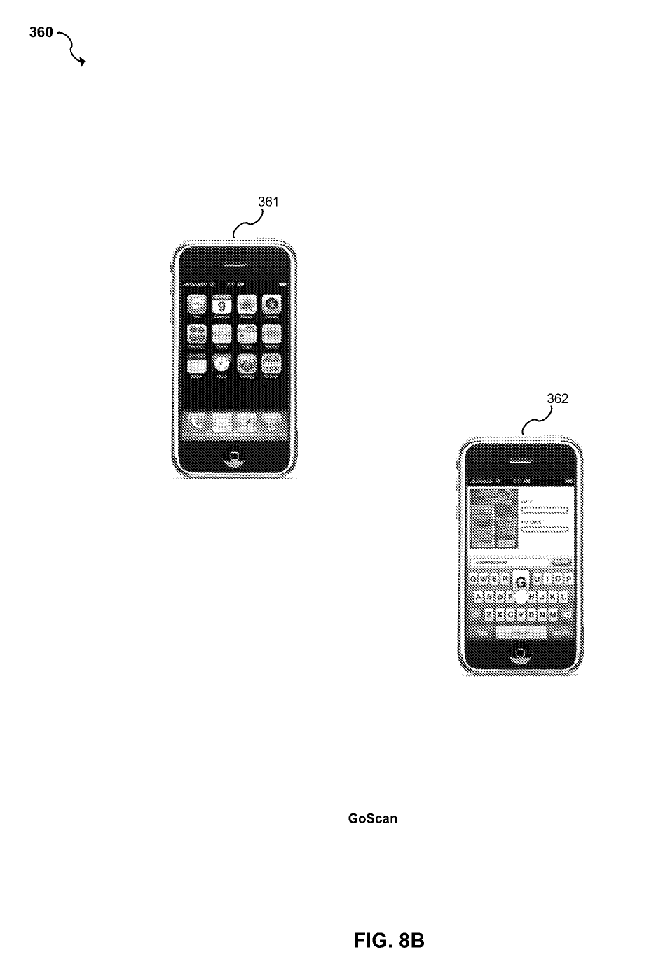

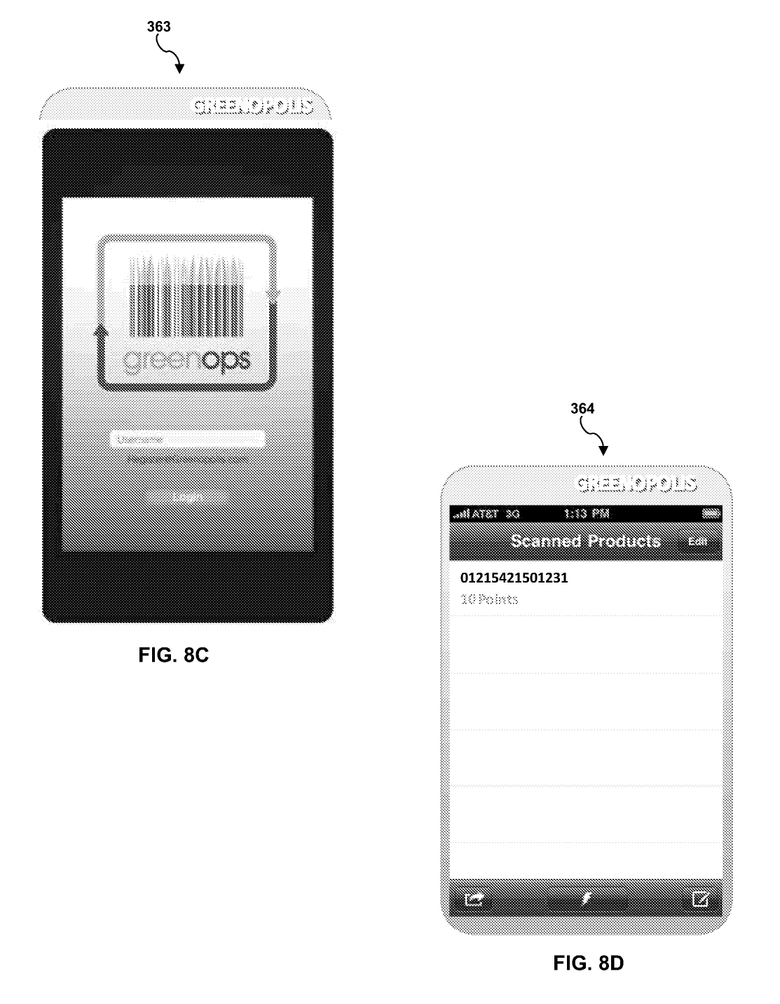

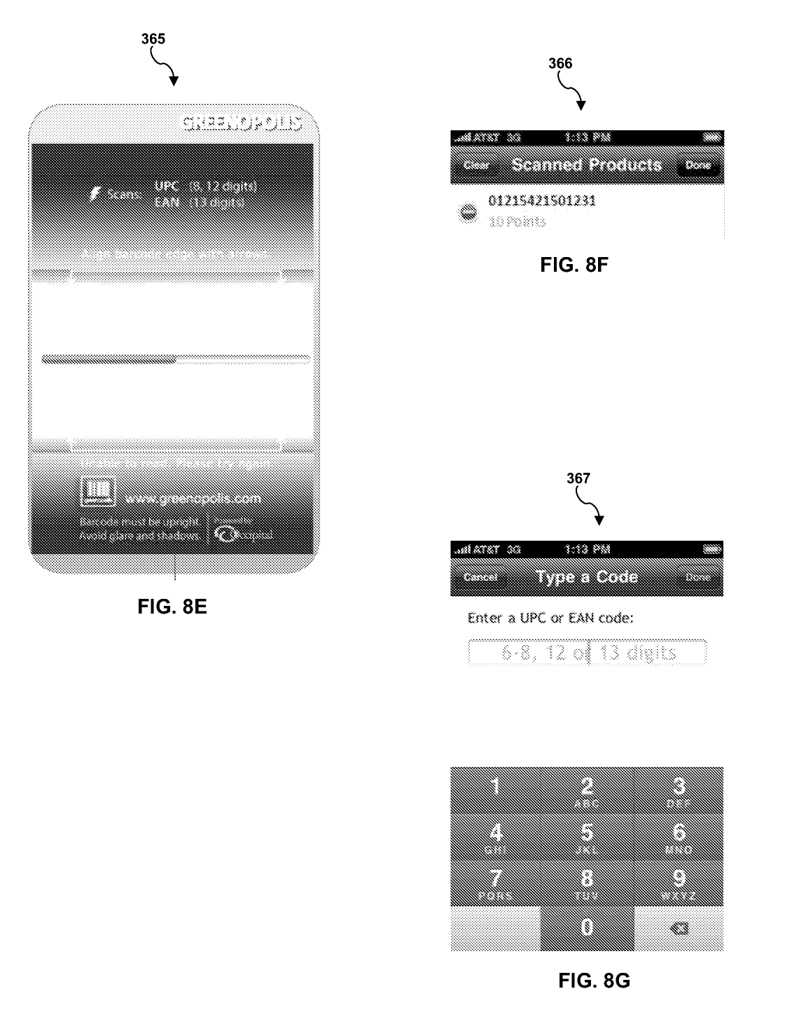

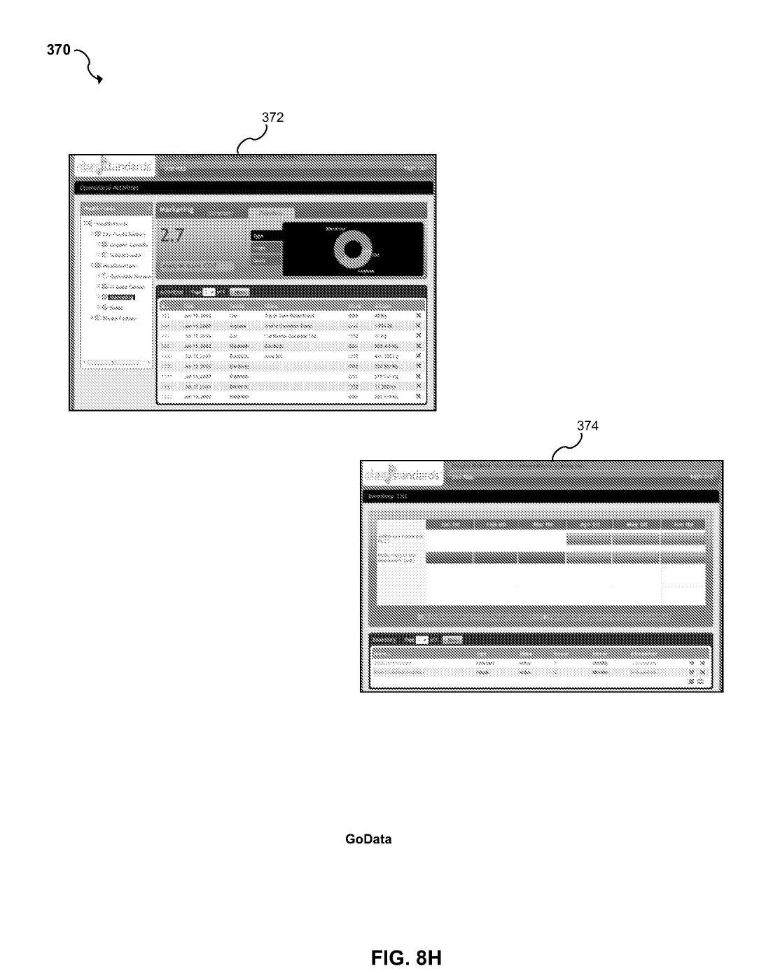

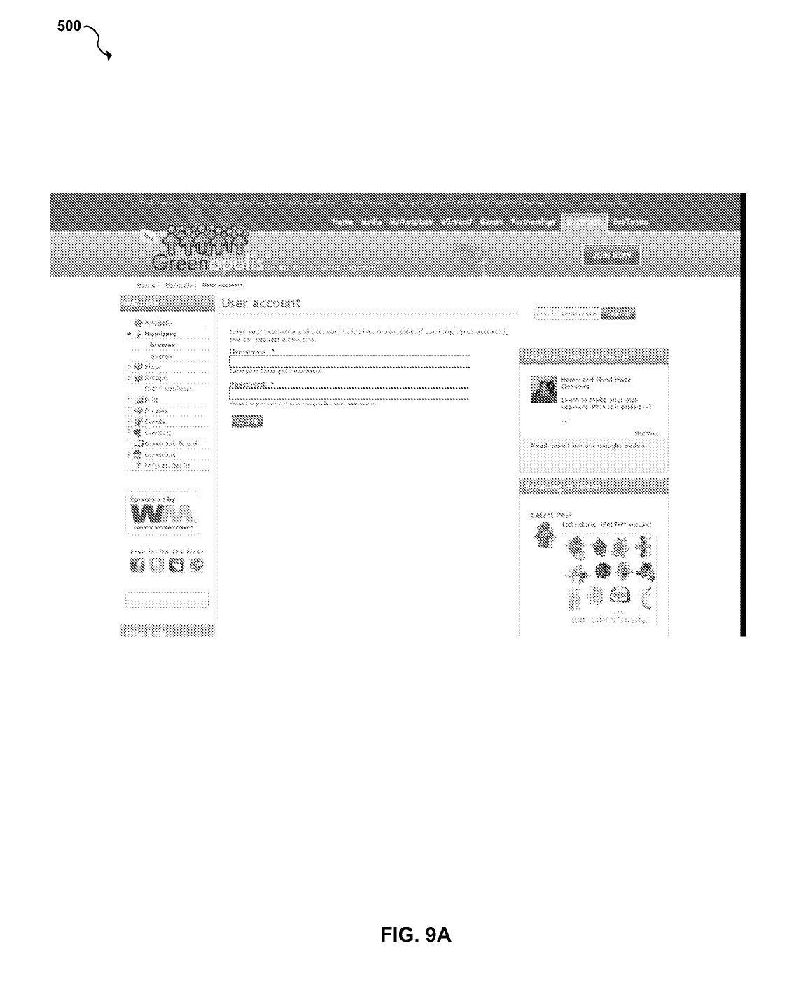

Referring to FIGS. 8C-8G, block diagrams illustrating one possible implementation of a scanning module implemented by a mobile device that is used to scan and review recycling activities in accordance with an embodiment of the present invention, is shown. According to this implementation, the recycling user logs in over a network to a server. The recycling user logs in to the server using a username and password, or other security mechanism. The recycling user downloads the scanning module as an application on a mobile device. Upon execution, the scanning module allows consumers at home to image and account for their home recycling by UPC, brand, or the like. Recycling activities are communicated to a server, such as without limitation a web server, over a network. Recycling activities may be converted to points for later redemption or charitable giving. Recyclable products put into recycling bins at curbside for collection. In certain collection route areas, the recyclable products are weighed and further point acquisition would occur by route or by weight divided by the number of homes or apartments in the route. In other collection route areas, consumers could still live in the WM world and derive points through their activities.

As shown in FIG. 8C, upon execution, the scanning module prompts the recycling user to login. The recycling user is prompted to provide an existing username and password or to register for a new account. As shown in FIG. 8D, the recycling user is presented with all previously scanned items and the reward points earned for each scanned item. Optionally, the recycling user may edit or delete scanned item entries. The user may scan recyclable materials using the scan screen shown in FIG. 8E. The scan screen allows the recycling user to capture the UPC, brand, or the like from the recyclable product. Based on the scan, the recyclable material is identified and reward points are added to the recycling user's reward point total. If the recyclable product is not identified, then the recycling user is prompted to either rescan the recyclable product or to manually enter information associated with the recyclable material as shown in FIG. 8G.

### VI. Godata

The present invention includes a scoring module that allows a recycling user to quantify recycling activities individually or as a group from various points of view, including without limitation, (i) gross reductions in carbon, green house gases, energy, petroleum, and the like, (ii) net reductions by comprehensive procurement guidelines (CPG) program, retailer, material, product category, and the like, (iii) net reductions by individual, demographic, zip code, state, redemption or non-redemption, and the like. The scoring module is configured to create a supply chain scorecard in support of a recycling business model and consumer recycling program at retail locations, at home, at stadiums, at recycling centers or stations, and the like.

Referring to FIG. 8H, a block diagram illustrating one possible implementation of a web-based recycling scorecard in accordance with an embodiment of the present invention is shown. According to this implementation, a supply chain scorecard is displayed in support of a recycling business model and consumer recycling program at retail locations, at home, at stadiums, at recycling centers or stations, and the like.

### VII. Goindustrial

The present invention includes the ability to integrate into materials recovery facilities (MRFs) or recycling centers or stations, material scanning control systems to further sort single, duel material streams or in support of product breakdown environments. According to at least one embodiment, various industrial control systems are interfaced to authenticate the capture and sort of various material streams. The data captured by this interface may be used for reporting based upon route logistics, material streams, CPG, consumer versus commercial and other data, along with and reports valued by the recycling entity, its partners, federal and state governments and consumer groups. The interface without limitation utilizes existing technologies, such as UPC, symbol, material, shape and other in place technologies. Existing line control systems, including magnetic, air and vibratory technologies are interfaced to sort deeper into material requirements and create cleaner end streams. The present invention provides greater sorting capabilities to the materials recovery facilities (MRFs) or recycling centers or stations because the detailed database information is available with respect to the particular recyclable product including its type, composition and content, once the recyclable product is identified. This detailed information may be used to provide additional sorting or routing capabilities.

Referring to FIG. 4F, a flow chart illustrating a method for receiving a recyclable at a materials recovery facility or a recycling center or station product in accordance with an embodiment of the present invention is shown. At block 332, the recyclable product is received at the materials recovery facility or the recycling center or station. Typically, this involves receiving co-mingled recyclable products from a recycling truck and placing the recyclable products on a moving conveyor belt, which distributes the material for inspection and separation. The recyclable product is identified at block 334. The identification may be performed by scanning a UPC, symbol, material, shape and other in place technology. The recyclable product may be scanned using without limitation a scanner, sensor, receiver, camera or the like. At block 336, the type of recyclable product is determined. Determining the type of product may include use of magnetic, air and vibratory technologies to sort deeper into material requirements. The type of recyclable product may also be determined using without limitation a scanner, sensor, receiver, camera or the like. For instance, a determination of whether the recyclable product is a bio hazard or non-bio hazard may be performed at this step. The recyclable product may also be sorted by without limitation PET/PE color, or based on whether it is organic or non-organic. The recyclable product may optionally be routed to an appropriate processing location based on the type of recyclable product, at block 338.

### VIII. Golearn, Gofaq and Gochat

In at least one embodiment, the tracking station includes a support module that is configured to provide recycling users with technical, support and/or other information about the tracking station via a graphical user interface on the tracking station.

Without limitation, the support module may be configured to provide educational videos or audio, answers to frequently ask questions (FAQs), and live video or audio chat sessions with a call center.

Educational videos or audio are provided by the support module based on different categories, including without limitation, age, grade for use by classrooms, individuals and community groups to distribute information about recycling, the environment, sustainability and other eco subjects. According to this embodiment, the graphical user interface provides the ability for consumers, children and others an interactive education based upon the program. Video content is sorted by grade for children and by subject for consumers. In a preferred embodiment, a button on the tracking station initiates a learning video.

Answers are provided by the support module to frequently ask questions (FAQ). According to this embodiment, the graphical user interface provides the ability for a recycling user to receive answers to frequently ask questions. In a preferred embodiment, a button on the tracking station initiates a FAQ session. The answers to frequently asked questions may be provided by any means, including without limitation via a video playback of answers, audio playback or text displayed on the graphical user interface.

Live chat sessions with a call-in center are provided by the support module to provide interactive answers to questions, such as how to use the system, from an expert or otherwise knowledgeable person. According to this embodiment, the graphical user interface provides the ability for a recycling user to initiate a video based chat between consumers at the tracking station with customer service personnel located at a call center. In a preferred embodiment, a button on the tracking station initiates a video chat with call center personnel. This button give consumers, children and others an interactive question and answer process to learn about the GreenOps program and help them use tracking stations and interface with Greenopolis.

Referring to FIG. 4E, a flow chart illustrating a method for interacting with a recycling user using a recycling center or station in accordance with an embodiment of the present invention is shown. At block 292, a graphical user interface is displayed on a recycling center or station.

According to one embodiment, the recyclable user is prompted to enter a user identification. The recyclable user may enter the user identification manually using the graphical user interface or a keyboard. The recyclable user may also enter the user identification via a key FOB, mobile identifier or the like. At block 296, the user identification is used to locate a user account in a database. The database may be physically located on the recycling center or station or may be located on a central server and the user identification is communicated to the central server via a communication network. If the user account is not located, then the recyclable user may be optionally prompted to enter information to add a new user account in the database at block 298. Otherwise, an error message is displayed to the recyclable user. At block 300, the user account is retrieved from the database. According to an alternate embodiment, blocks 294-300 are not performed and processing continues to block 302.

At block 302, one or more menu options are displayed on the graphical user interface. The one or more menu options include without limitation (i) managing at least a portion of the information associated with the user account (block 302); (ii) displaying one or more FAQs about the recycling center or station, recycling generally, or about environmentally friendly programs in which the recycling user may participate (block 304); (iii) displaying or listening to a educational video or audio file, respectively (block 306); (iv) redeeming or transferring reward points associated with the recyclable user (block 308); and (v) initiating a live video or audio chat session with a representative at a call center (block 310). Each of the above menu options are processed at blocks 312-320.

### XI. Custom Tracking Stations

The present invention includes a tracking station that is configured to handle numerous types of recyclable products, including without limitation, medical waste, consumer electronics, shoes, clothing, digital video discs (DVDs), compact discs (CDs), appliances, magazines and the like. The tracking station includes a baseline capture engine for other market opportunities and potential integration of capture engine into other third party equipment.

The present invention thus includes a computer program which may be hosted on a storage medium and includes instructions which perform the processes set forth in the present specification. The storage medium can include, but is not limited to, any type of disk including floppy disks, optical disks, CD-ROMs, magneto-optical disks, ROMs, RAMs, EPROMs, EEPROMs, flash memory, magnetic or optical cards, or any type of media suitable for storing electronic instructions.

Obviously, many other modifications and variations of the present invention are possible in light of the above teachings. The specific embodiments discussed herein are merely illustrative, and are not meant to limit the scope of the present invention in any manner. It is therefore to be understood that within the scope of the disclosed concept, the invention may be practiced otherwise then as specifically described.

1. A computer program product embodied on a computer readable medium for managing an online recycling operation, the computer program product comprising:
a first computer code for uniquely associating one or more recyclable products with unique identifiers and other product information stored in a database, wherein each recyclable product includes indicia that uniquely identifies the recyclable product;
a second computer code for receiving information associated with the one or more recyclable products;
a third computer code for periodically storing and updating the information associated with the one or more recyclable products in the database;
a fourth computer code for associating the unique identifier with a recycling user having user account information stored in the database, wherein the user account information includes user information comprising a reward point total and recycling data associated with the recycling user;
a fifth computer code for updating the reward point total based on an activity of the recycling user, wherein the activity comprises recycling activities and active participation on an environmentally-friendly web server;
a sixth computer code for communicating the product information and the user account information to the recycling user over the network;
a seventh computer code for communicating rewards that are available in exchange for reward points to the recycling user over the network; and
an eighth computer code for redeeming reward points upon demand by the recycling user over the network.

2. The computer program product of claim 1, wherein the active participation on the environmentally-friendly web server includes posting blog entries on the web server.

3. The computer program product of claim 1, wherein the activity further comprises encouraging other users to perform recycling activities.

4. The computer program product of claim 1, wherein the indicia is both a unique scannable identifier and a visual indicator that the recyclable product is recyclable, and the visual indicator is arranged to encourage recycling.

5. The computer program product of claim 4, wherein the indicia is a unique barcode combined with a graphical symbol indicating to the recycling user that the one or more recyclable products are recyclable.

6. The computer program product of claim 4, wherein the indicia is a variable scan tracking symbol combined with a graphical symbol indicating to the recycling user that the one or more recyclable products are recyclable.

7. The computer program product of claim 4, further comprising a ninth computer code for receiving tracking information associated with the one or more recyclable products, wherein the tracking information includes information scanned at one or more stages of the lifecycle of the one or more recyclable products;

8. The computer program product of claim 7, further comprising a tenth computer code for scanning the barcode and communicating tracking information to the database via the network.

9. The computer program product of claim 4, wherein the indicia is an optically scannable unique identifier combined with a graphical symbol indicating to the recycling user that the one or more recyclable products are recyclable.

10. The computer program product of claim 1, wherein the indicia is an optically scannable using at least one of an x-ray, an opti-scanner, a material resonance scanner, and a UV scanner.

11. The computer program product of claim 4, wherein the indicia is an RFID combined with a graphical symbol indicating to the recycling user that the one or more recyclable products are recyclable.

12. The computer program product of claim 1, wherein the indicia is a unique barcode.

13. The computer program product of claim 12, wherein the barcode is sequential and predictable.

14. The computer program product of claim 12, wherein the unique barcode is non-sequential and non-predictable.

15. The computer program product of claim 1, wherein at least one of the product information and account information is communicated to the recycling user over the network via at least one selected from the group consisting of SMS, an email and a communication protocol.

16. The computer program product of claim 1, further comprising a ninth computer code for verifying a status of one or more recyclable products using at least one selected from the group consisting of SMS, a hand-held scanner, and a camera phone.

17. The computer program product of claim 1, further comprising a ninth computer code for allowing the recycling user to confirm that the one or more recycling products has been reprocessed.

18. The computer program product of claim 1, further comprising a ninth computer code for allowing the recycling user to confirm that the one or more recycling products contain toxic materials.

19. The computer program product of claim 1, wherein the recyclable products comprise at least one selected from the group consisting of a plastic bottle, a glass bottle, a plastic container, a glass container, a metal container, paper, an electronic product and a medical product.

20. A system for managing and tracking recyclable products, the system comprising:
a plurality of remote computers of recycling users;
a central server;
a network interface in communication with the central server and the plurality of remote computers over a network, the network interface being configured to receive information associated with one or more recyclable products;
a database in communication with the central server;
wherein the central server is configured to:
uniquely associate one or more recyclable products with unique identifiers and other product information stored in a database, wherein each recyclable product includes indicia that uniquely identifies the recyclable product;
receive information associated with the one or more recyclable products;
periodically store and update the information associated with the one or more recyclable products in the database;
associate the unique identifier with a recycling user having user account information stored in the database, wherein the user account information includes user information comprising a reward point total and recycling data associated with the recycling user;
update the reward point total based on an activity of the recycling user, wherein the activity comprises recycling activities and active participation on an environmentally-friendly web server;
communicate the product information and the user account information to the recycling user over the network;
communicate rewards that are available in exchange for reward points to the recycling user over the network; and
redeem reward points upon demand by the recycling user over the network.

21. The system of claim 20, wherein the active participation on the environmentally-friendly web server includes posting blog entries on the web server.

22. The system of claim 20, wherein the activity further comprises encouraging other users to perform recycling activities.

23. The system of claim 20, wherein the indicia is a unique barcode combined with a graphical symbol indicating to the recycling user that the one or more recyclable products are recyclable.

24. The system of claim 20, further comprising an optical scanner configured scan the barcode and communicate tracking information to the database via the network.

25. The system of claim 20, wherein the indicia is an optically scannable unique identifier combined with a graphical symbol indicating to the recycling user that the one or more recyclable products are recyclable.

26. The system of claim 25, wherein the optically scannable identifier is scanned using at least one of an x-ray, an opti-scanner, a material resonance scanner, and a UV scanner.

27. The system of claim 20, wherein the indicia is an RFID combined with a graphical symbol indicating to the recycling user that the one or more recyclable products are recyclable.

28. The system of claim 20, wherein the indicia is a unique barcode that is sequential and predictable.

29. The system of claim 20, wherein the indicia is a unique barcode that is non-sequential and non-predictable.

30. The system of claim 20, wherein at least one of the product information and account information is communicated to the recycling user over the network via at least one selected from the group consisting of SMS, an email and a communication protocol.

31. The system of claim 20, further comprising verifying a status of one or more recyclable products using at least one selected from the group consisting of SMS, a hand-held scanner, and a camera phone.

32. The system of claim 20, further comprising allowing the recycling user to confirm that the one or more recycling products has been reprocessed.

33. The system of claim 20, further comprising allowing the recycling user to confirm that the one or more recycling products contains toxic materials.

34. The system of claim 20, wherein the recyclable products comprise at least one selected from the group consisting of a plastic bottle, a glass bottle, a plastic container, a glass container, a metal container, paper, an electronic product and a medical product.

35. A computer program product embodied on a computer readable medium for managing an online recycling operation, the computer program product comprising:
a first computer code for uniquely associating one or more recyclable products with unique identifiers and other product information stored in a database, wherein each recyclable product includes indicia that uniquely identifies the recyclable product;
a second computer code for receiving information associated with the one or more recyclable products;
a third computer code for periodically storing and updating the information associated with the one or more recyclable products in the database;
a fourth computer code for associating the unique identifier with a recycling user having user account information stored in the database, wherein the user account information includes user information comprising a reward point total and recycling data associated with the recycling user;
a fifth computer code for updating the reward point total based on a recycling activity of the recycling user;
a sixth computer code for communicating the product information and the user account information to the recycling user over a network; and
a seventh computer code for redeeming reward points upon demand by the recycling user over the network, wherein the sixth and seventh computer codes are implemented on web server and a recycling station in communication with the database over the network.

36. A computer program product embodied on a computer readable medium for interacting with a recycling user on a recycling center or station, the computer program product comprising:
a first computer code for automatically receiving a user identifier using a recycling center or station;
a second computer code for communicating the user identifier from the recycling center or station to a central computer via a communications network;
a third computer code for receiving the user identifier at the central computer and associating the user identifier with a recycling user having user account information stored in the database, wherein the user account information includes user information comprising a reward point total and recycling data associated with the recycling user;
a fourth computer code for transmitting at least a portion of the user account information from the central computer to the recycling center or station;
a fifth computer code for receiving the at least a portion of the user account information at the recycling center or station; and
a sixth computer code for implementing a graphical user interface on the recycling center or station to the recycling user.

37. The computer program product of claim 36, further comprising a seventh computer code for displaying the at least a portion of the user account information on the graphical user interface to the recycling user.

38. The computer program product of claim 37, wherein the graphical user interface includes an option to manage the user account information associated with the recycling user.

39. The computer program product of claim 37, wherein the at least a portion of the user account information includes the reward point total.

40. The computer program product of claim 39, wherein the graphical user interface includes an option to manage reward points upon demand by the recycling user at the recycling center or station.

41. The computer program product of claim 40, managing reward points comprise redeeming reward points.

42. The computer program product of claim 40, managing reward points comprise transferring reward points.

43. The computer program product of claim 36, wherein the graphical user interface includes an option to initiate a live chat or video session.

44. The computer program product of claim 36, wherein the graphical user interface includes an option to display one or more FAQs.

45. The computer program product of claim 36, wherein the graphical user interface includes an option to display one or more videos.

46. The computer program product of claim 45, wherein the one or more videos comprise educational videos.

47. A computer program product embodied on a computer readable medium for receiving a recyclable product at a materials recovery facility or a recycling center or station, the computer program product comprising:
a first computer code for identifying a recyclable product at a recycling center or station;
a second computer code for determining a type of the recyclable product, wherein the type comprises one selected form the group consisting of a bio hazard type and a non-bio hazard type; and
a third computer code for routing the recyclable product based on the type to an appropriate processing location.

48. The computer program product of claim 47, wherein the type further comprises one selected from the group consisting of glass, plastic, and metal.

49. The computer program product of claim 47, wherein the determination of the type comprises optically scanning the recycling product.

50. The computer program product of claim 49, wherein the determination of the type further comprises matching a scanned image of the recycling product with an image in a database using fuzzy logic.
